(19) United States
(12) Patent Application Publication
(10) Pub. No.: US 2010/0279881 A1
(43) Pub. Date: Nov. 4, 2010

(54) Epitope-mediated antigen prediction

(76) Inventors: Seshi R. Sompuram, Arlington, MA (US); Steven A. Bogen, Sharon, MA (US)

Correspondence Address: STEPTOE & JOHNSON LLP, 1330 CONNECTICUT AVENUE, N.W., WASHINGTON, DC, 20036, US

(21) Appl. No.: 12/525,605

(22) PCT Filed: Jan. 31, 2008
(86) PCT No.: PCT/US08/52606

§ 371 Date: Jun. 25, 2010

Related U.S. Application Data
(60) Provisional application No. 60/887,916, filed on Feb. 2, 2007.

(51) Int. Cl. C40B 30/02

(52) U.S. Cl. 506/8

(57) ABSTRACT

There are many clinical instances in which, during the course of a disease, a patient may produce an antibody directed to unknown protein target(s). The targeted antigen(s) may be autoantigens (e.g., autoimmune diseases), microbial antigens (e.g., infectious diseases), allergens or, as in the case of B lymphoproliferative disorders and monoclonal gammopathies, antigens of unknown identity. When the antigen source is known or suspected, it may be feasible to construct a cDNA expression library and identify it. However, with no clues as to the antigen's origin, expression screening is impossible. We describe a new search strategy to overcome this limitation. We term the approach Epitope-Mediated Antigen Prediction (E-MAP). The technology enables one to link antibodies of unknown specificity to their cognate/target antigens in the protein database without requiring prior knowledge of their cellular source. We also describe a clinical application of the E-MAP technology to the study of multiple myeloma. In this study, we identified the protein target of paraproteins from a number of patients with multiple myeloma. These methods will be useful in biomarker discovery, clinical diagnostics, and therapeutic drug lead identification.

### CLAIM OF PRIORITY

This application claims priority to U.S. Provisional Application Ser. No. 60/887,916, filed on Feb. 2, 2007, which is hereby incorporated by reference in its entirety.

### FEDERALLY SPONSORED RESEARCH OR DEVELOPMENT

The invention was supported, in whole or in part, by grants R44CA81950 and R44CA094557 from The National Institutes of Health. The Government has certain rights in the invention.

### BACKGROUND

In the investigation of the causes of human disease, there are still many diseases of unknown etiology, or whose etiology is still not well understood. Identifying the cause of disease is of obvious importance, both in developing treatments and better diagnostic tests. At least in some of these diseases, the patient's immune system will mount an immune response that is associated with the disease process. An antibody may be produced in an attempt to eliminate the disease-causing agent. For example, if a microorganism causes a disease, the host will usually mount an immune response (comprising antibodies and/or T lymphocytes) that are specific for the microorganism. Alternatively, the antibody may be autoimmune in nature. In other instances, antibodies may be produced against tumor-associated proteins. Regardless, the immune response might reveal valuable information to help us understand the cause of the disease. Unfortunately, there is currently no technology for identifying the target of an immune response if it is otherwise unknown, without ancillary clinical clues to facilitate an educated guess. Serologic immunoassays (measuring antibody responses) all require that the antigen is already known.

Previous investigators have used an expression screening approach in trying to identify antigens that bind to antibodies of unknown target specificity. One such approach was termed “SEREX” (serological analysis of recombinant cDNA expression) and involved screening libraries of human tumors with autologous serum). SEREX provided for the identification of antigens from a pool of candidate proteins. However, as an expression screening technology, it requires prior knowledge about the cellular source of the antigen. Therefore, the range of possible protein antigens to be identified is limited to those expressed by the cell type used as a source for constructing the cDNA expression screening library. There are many diseases, however, in which the nature of the antigen is completely unknown. In these diseases, the immune response may potentially point to an etiologic agent. Without at least some initial clues from a clinical context, it has not previously been possible to identify an antibody's target protein.

### SUMMARY

A new platform discovery technology harnesses the ability of the immune response to identify disease-associated proteins recognized by the immune system. This new technology is unique in that it doesn't necessarily require prior assumptions about the source of the antigen, providing an entirely new capability with which to explore disease pathophysiology. We call it “Epitope-Mediated Antigen Prediction (E-MAP)”. E-MAP is a protein identification technology. With E-MAP, we search broadly through the protein database using an antibody's predicted epitope as an in silico search probe.

E-MAP comprises at least two new aspects that make it possible to successfully identify antigens from antibodies. First, we have developed a method to identify a peptide sequence that reasonably accurately represents the epitope in the native protein sequence. We accomplished this by discovering that native protein sequences usually have higher affinities for the antibody as compared to homologous peptides that also bind to the antibody. Therefore, we developed methods of screening peptide combinatorial phage libraries that stringently select the most avidly binding phage. We also determined the effect of mismatches between the predicted and actual linear sequence and identified the thresholds of accuracy that are necessary in order to obtain an accurate match from the protein database.

In a second aspect, a bioinformatics search method is described. A significant hurdle in protein database searching with predicted epitopes was that single epitopes usually do not have enough information to accurately narrow down the list of candidate proteins if the entire protein database is searched, which includes proteins from all organisms. With 4-6 amino acids, there are too many protein database hits. We have discovered that this problem can be solved by searching with two epitope motifs simultaneously, from two different antibodies. We demonstrate for the first time that a concurrent search with two short epitope motifs, derived from the epitopes of two different antibodies to the same protein, contain sufficient information so as to converge on the true target. Such a pairwise search imposes the constraint that both antibodies must bind to the same protein.

It is usually not possible to know, a priori, if the two antibodies (of unknown specificity) bind to the same antigen. It is a trial and error process. Therefore, we assessed the consequences of searching with two motifs belonging to two different proteins. We find that such mismatched searches do not generate long lists of irrelevant database hits. The few hits that do result can usually be distinguished from true matches. The E-MAP method can be useful in a clinical context where more than one antibody to an etiologic agent is present.

As yet an additional aspect, the use of various immunoassays for human herpesvirus 5 (cytomegalovirus) in determining the antigen binding specificity of a paraprotein in multiple myeloma is described. The same can be true for the immunoglobulin synthesized by malignant lymphocytes in other gammopathies and lymphoproliferative disorders, such as amyloidosis AL, lymphoma, and leukemia. These immunoassays can take various forms, and examples are described herein that include both solid phase immunoassays and electrophoretic blots.

### BRIEF DESCRIPTION OF THE DRAWINGS

FIG. 1 is a schematic representation of the two-step process comprising the E-MAP technology. Two antibodies, labeled “Ab1” and “Ab2”, are directed to two different linear epitopes on a hypothetical protein antigen. These epitopes are in bold on the protein antigen and also shown in an exploded view. The identity of the amino acids is arbitrarily designated with the letters A-E or L-P, for illustrative purposes. In step 2, the predicted epitopes, identified by phage display of peptide combinatorial libraries, are used in pairwise submissions to search a protein database.

FIG. 2 is a graph, examining the predicted relationship between the peptide epitope length and average motif conservation on the success rate in bioinformatic searching of the non-redundant (entire) protein database, containing proteins from all species. The “average motif conservation” is defined as the proportion of amino acids in the experimentally-derived, predicted epitope that is identical to the amino acids in the epitope of the actual protein. The “success rate” is defined as the proportion of protein database searches that resulted in the correctly matching protein amongst the top ten database hits. Each point represents the mean±SD of 40 searches from 40 different randomly selected proteins.

FIG. 3A is a stacking graph of a hypothetical result from a protein database search from an epitope motif that is insufficiently long to definitively identify the true match. Each circle represents a result from the protein database search. Irrelevant database matches are represented as open circles (∘). The true match is illustrated as a black circle (). The x axis (p value) represents the likelihood that the match between the predicted epitope and the database search result occurs by random chance. The hypothetical true match is shown to be indistinguishable from other database hits with comparable p values, as is typical with a single epitope search.

FIG. 3B is a scatter plot of a pairwise epitope submission search result from the protein database. The true match is distinguished from other search results as having a low p value along both search parameters (x and y axes), and is therefore distinguished from irrelevant search results.

FIG. 4 is a listing of the peptide sequences identified after biopanning from a peptide combinatorial library using four different monoclonal antibodies. Two monoclonal antibodies are specific to the human progesterone receptor (PR) and the other two bind to the human estrogen receptor (ER). Each letter represents an amino acid (standard single letter code). The sequences are aligned to show areas of homology, which are bolded.

FIG. 5 is a listing of the protein database search results when correctly matched pairs of data sets were used. In the upper listing, the search results from two different PR antibodies are listed. The lower listing includes the search results from two different ER antibodies.

FIG. 6 is a listing of the protein database search results when incorrectly matched pairs of data sets were used.

FIG. 7 is a representative immunoblot of round three enriched phage after enrichment using the paraprotein from patient 20. The phage library was panned against paramagnetic beads bearing the paraprotein from patient 20. The left-hand blot represents the image after immunodetection using the serum from patient 20. The right-hand blot represents the image after immunodetection with normal serum, without a paraprotein. The boxes identify markings that we placed on the replicate lifts, for purposes of alignment.

FIG. 8 is a listing of amino acid sequences from the peptide inserts of immunoreactive phage clones, from the analysis of phage that bind to paraproteins of patients 12 and 20. The sequences are aligned by their consensus peptide sequences, which are delimited by the boxes. For patient 20, two distinct consensus peptide sequences emerged and they are grouped in the figure accordingly. Glycines that are part of the invariant carboxy terminus are italicized (G). The patient 20 sequences at the bottom, from phage clones 20-5 until 20-56, are independent clones having the exact same sequence. Redundant sequences are in gray. This sequence was weighted as only one entry when calculating the dominant motif.

FIG. 9 illustrates serum protein electrophoresis images from a normal, healthy control individual (left) as compared to those of serum from patients 12 (middle) and 20 (right). The gel anode is to the top, cathode to the bottom. Paraproteins are denoted with arrows.

FIG. 10 is a graph depicting data from a phage ELISA, demonstrating that paraproteins from patients 12 and 20 are immunoreactive to the same peptide epitope, expressed on phage particles. Phage preparations, rounds 1-3 (“Rd 1, Rd2, Rd3”) were enriched for binding to the paraproteins of patient 12 or 20, as indicated in the inset. We also tested immunoreactivity to the unselected linear library (“L-20 Unselected”).

FIG. 11 is a short peptide segment from glycoprotein B and the UL-48 gene product, both from the native sequence of human herpesvirus 5. Paired alongside each is a comparison to the consensus peptide sequence used for BLAST searching. Solid lines between the two represent identity. Dotted lines represent conserved substitutions. “X” represents an amino acid position that could not be identified from the phage display data.

FIG. 12 is a bar graph demonstrating the immunoreactivity of sera from patients 1-40 with a recombinant fragment of glycoprotein B, human herpesvirus 5 in an ELISA. The results with the kit-supplied negative (−) and positive (+) controls are also shown. Whereas the manufacturer's controls are diluted 1:4, as per the kit recommendations, the patient sera are diluted 1:500 so that they fall within the linear range of the assay.

FIG. 13 is a bar graph demonstrating the immunoreactivity of sera from patients with human cytomegalovirus lysate in a VIDAS commercial ELISA. Values above 4 are considered positive by the manufacturer. Sera were diluted ten-fold beyond the manufacturer's recommendation, so that the values fall within the linear range of the assay.

FIG. 14 is a bar graph depicting the immunoreactivity of paraproteins from patients 1-40 with the UL-48 gene product amino terminus, amino acids 1-20. Sera were diluted 1:250. Each bar represents the mean of duplicate measurements.

FIG. 15 is a composite aligned image of serum protein electrophoretic analysis and immunoblots of the serum from patient 20. The serum protein electrophoresis (SPEP) pattern (lane 1) was detected by amido black staining of the gel. The anode (positive pole) is towards the top, with albumin (“ALB”) being the most anodal serum protein visible in the gel. The serum paraprotein is denoted with an arrow. Lanes 2-4 are replicates of lane 1, blotted onto a nitrocellulose membrane, and immunostained with various probes. Lane 2 was immunostained with a human IgG-specific antibody conjugate. Lanes 3 and 4 were immunostained with the indicated phage clones. Clone 20-61 is derived from motif 1, containing the UL48 gene product paraprotein epitope. Clone 20-41 is derived from motif 2, containing the gpB AD-2S1 epitope. Sera are undiluted in lane 1, and diluted 1:10 or 1:100 for lanes 2-4.

FIG. 16 is a composite aligned image of serum protein electrophoretic analysis and immunoblots of the sera from patients 12 and 20. Agarose gel immunoblots demonstrate the specific paraproteins responsible for immunoreactivity of patients 12 (left) and 20 (right) against HCMV. Patient sera were undiluted in lane 1 and diluted 20×-750× for lanes 2-6, depending upon the lane. Lane 1 depicts the serum protein electrophoresis (SPEP) pattern of major serum protein bands, as stained with amido black, without any protein transfer onto nitrocellulose. The image is that of the gel itself. The arrow and dashed line denote the gel position of the serum paraprotein. The images for lanes 2-6 were scanned from a photographic film, after exposure to a nitrocellulose membrane. For lane 2, the membrane was probed for the presence of human IgG. For lanes 3-4, nitrocellulose membranes were pre-coated (prior to protein transfer) with inactivated, density-gradient purified HCMV whole virion (lane 3) or the antigenically unrelated M13 virus (lane 4). For lanes 5-6, nitrocellulose membranes were pre-coated with an HCMV lysate (lane 5) or a mock lysate derived from uninfected cells (lane 6). Each patient's image therefore represents a composite. For patient 12, the non-specific band that is present in both the HCMV lysate lane (lane 5) and mock lysate lane (lane 6) does not co-migrate with the paraprotein (lane 1, arrow).

FIG. 17 is a composite aligned image of electrophoretic gels from six other multiple myeloma patients. The left lane depicts the serum protein electrophoresis (SPEP) pattern of major serum protein bands. The SPEP image is that of the gel itself, without transfer to nitrocellulose. The arrow identifies the paraprotein. The IgG lane is from an immunofixation with anti-IgG or anti-light chain antisera. The image is the gel itself, without transfer to a membrane. The images for the lysate lanes were scanned from a photographic film, after exposure to a nitrocellulose membrane. The membrane was pre-coated with either an HCMV lysate (“CMV”) or a mock lysate from the uninfected cell line (“Mock”) prior to contact transfer. Patient sera were undiluted for SPEP, diluted 1:6 for IgG immunofixation, and diluted approximately 1:200 for the immunoblot lanes. For patient 36, a yellow dashed ellipse is placed to illustrate that, although both lysates lanes have a weakly staining non-specific background, the Mock lysate lane does not contain the intensely staining CMV-specific band.

FIG. 18 is an amino acid sequence of a portion of the human endogenous retrovirus K envelope protein, showing homologous alignment of the consensus motifs from patients 14 and 21.

### DETAILED DESCRIPTION

A technology to identify the antigenic target of disease-associated antibodies, not encumbered by the need to know the target's cellular source in advance, would be a valuable tool in life sciences research. Such a technology could take advantage of the fact that the antigen combining site is a unique structural aspect of every antibody. A portion of the antigen (the “epitope”) fits into the three-dimensional pocket of the antibody's antigen combining site (the “paratope”). By using an antibody to identify the amino acid sequence that comprises the epitope, such a technology would ideally link disease-associated antibodies with the protein antigens to which they bind. Thus, the unique linear sequence of an epitope might be considered analogous to a fingerprint. Just as it is possible to identify a person from a mere fingerprint, a technology to identify an antigen from just an antibody's epitope might create new opportunities in life sciences research.

It is technically possible to identify peptides that bind to the antigen-binding site of antibodies. These peptides are identified from peptide combinatorial libraries, usually expressed in M13 bacteriophage. This approach has been useful where the protein antigen is known, and the investigator is trying to identify the specific epitope on the protein to which the antibody binds. There are many examples in the published literature of epitope mapping using phage displayed peptide combinatorial libraries. In those examples, investigators deduce the epitope by analyzing the peptide inserts from phage that bind to the antibody. The epitope in the native protein is identified by searching for areas of similarity between the peptide inserts and the protein's amino acid sequence.

It has not previously been possible, however, to use these peptide inserts to identify unknown target proteins. A short peptide motif (4-6 amino acids) does not possess enough information content to uniquely identify a candidate antigen in broad bioinformatic searches of proteins from all species (i.e., the non-redundant protein database). The retrieved hit list from a protein database search is usually large, with hundreds or thousands of database hits effectively burying the true matching protein in the noise of extraneous results. In this patent application, we describe a technology to solve this problem.

There are three general obstacles to identifying a protein from a database using experimentally characterized epitope motifs. First, there is always some degree of uncertainty in reconstructing an epitope by phage display of peptide combinatorial libraries. A peptide combinatorial library, also known as a “random peptide library”, is comprised of a large collection of peptides, typically expressed in a vector, such as M13 bacteriophage. Each phage particle typically expresses a peptide on its surface that is usually different from the next phage particle, due to chance random combination from when the library was constructed. For us to reconstruct a peptide epitope by screening and analyzing a phage display library, it is necessary to identify a peptide that accurately represents the epitope of the native protein. However, antibody binding is somewhat promiscuous, in that antibodies will bind to many homologous peptides with varying affinities. It is important to develop a method to identify the peptide that, as accurately as possible, represents the native protein epitope.

In addition, even with a peptide that accurately represents the epitope in the native protein, the peptide must have sufficient information content (length) so as to distinguish the true match from the many other proteins in the database that are similar. Most epitopes do not have a sufficient number of amino acids to do that. With a typical 4-6 amino acid peptide that is identified from phage display, hundreds or even thousands of plausible protein matches will result from a protein database search, especially if allowance is provided in the search parameters for one or two errors or conserved substitutions. A method to further narrow the search is needed before this approach will be practical.

Lastly, proteins are catalogued in protein databases by their linear amino acid sequences. Therefore, a technique using protein database searching, such as E-MAP, only works if the predicted epitopes represent linear determinants. Since we cannot know a priori which predicted epitopes are linear versus conformational, this uncertainty might potentially lead to false matches. We investigated the potential impact of these parameters to bioinformatics searches.

In this study, we also apply the E-MAP technology to an exemplary disease context—multiple myeloma. It is generally believed that malignant transformation in multiple myeloma is due to the accumulation of mutations in the cell cycle and apoptosis regulatory control genes, leading to uncontrolled cellular proliferation. There has been little consideration to the role of antigen, such as infectious agents, as a growth stimulus for the malignant cells of multiple myeloma. One way to determine the antigenic specificity of myeloma cells would be to analyze the antigenic specificity of the secreted paraprotein. The secreted paraprotein has the same target specificity as the B cell receptor, and therefore is a convenient protein for analysis, as it is abundantly present in serum

The literature on paraproteins includes descriptions of paraprotein targets that were identified by chance clinical associations. They include individual case reports of paraproteins binding to the p24 gag protein of HIV [Jin, D., et al. Amer. J. Hematol. (2000) 64:210-213.], cytomegalovirus [Kohler, M., et al. Blut. (1987) 54:25-32.], or streptolysin-O [Waldenstrom, J., et al. Acta Medica Scandinavica. (1964) 176:619-631; Seligmann, M., et al. Nature. (1968) 220.], all of which were identified after serological assays on the patients came back with unexpectedly strong positive results. In other cases, a handful of paraproteins immunoreactive with carbohydrate specificities were identified after testing dozens or hundreds of paraproteins for immunoreactivity to various bacteria.[Kabat, E., et al. J. Exp. Med. (1980) 152:979-995; Emmrich, F., et al. Scand J Immunol. (1985) 21:119-126.] These cases likely represented cross-reactive epitopes and not the actual microbial antigen that stimulated immunoglobulin synthesis prior to malignant transformation. Therefore, there is little already known about the antigens to which paraproteins bind.

In the example of multiple myeloma, E-MAP analysis directed us to the human herpesvirus 5, also known as human cytomegalovirus (CMV or HCMV, used interchangeably). CMV is known to be a powerful immune stimulus, often resulting in such a profound clonal expansion as to produce paraproteins in otherwise healthy individuals [Buhler, S., et al. Clin Infect Dis. (2002) 35:1430-3.] as well as immunosuppressed patients. [Vodopick, H., et al. Blood. (1974) 44:189-195.]

In normal, healthy HCMV seropositive individuals, HCMV-specific CD8+ T lymphocytes comprise approximately 0.1% of the peripheral blood population, as measured by limiting dilution analysis. [Wills, M., et al. J Virol. (1996) 70:7569-7579.] The proportion of HCMV-reactive lymphocytes increases with age, exacting an increasingly heavy burden in elderly individuals. MHC tetramer analysis of elderly HCMV-seropositive individuals indicates that, on average, approximately 5% [Komatsu, H., et al. Clin. Exp. Immunol. (2003) 134:9-12; Khan, N., et al. J Immunol. (2002) 169:1984-1992.] of the CD8+ T lymphocytes may be specific for the HCMV pp65 immunodominant peptide. This figure may underestimate the percentage of T lymphocytes reactive with HCMV proteins since, contrary to previous belief, the T cell repertoire is not as focused solely on pp65 as was originally thought. [Khan, N., et al. J Immunol. (2002) 169:1984-1992; Elkington, R., et al. J Virol. (2003) 77:5226-5240.] Such a long-lasting, strong immune response to a single agent, years after initial exposure, may be due to chronic repetitive viral reactivation. [Sissons, J., et al. J Infec. (2002) 44:73-77; Soderberg-Naucler, C. J Intern Med. (2006) 259:219-46.] As a consequence, HCMV induces significant alterations in the immune parameters of elderly individuals. [Wikby, A., et al. Exp. Gerontol. (2002) 37:445-453; Looney, R., et al. Clin. Immunol. (1999) 90:213-219.]

E-MAP Protocol Overview

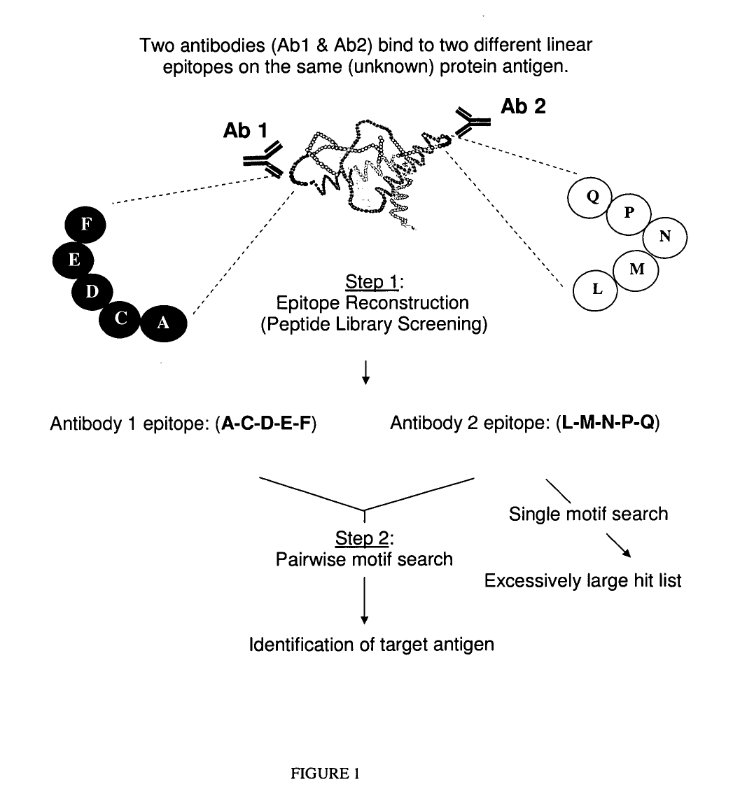

The E-MAP method incorporates two components, illustrated schematically in FIG. 1. First, we use a random peptide combinatorial library to elucidate the sequence composition of at least four amino acids comprising the antibody's epitope. We shall also refer to this elucidated peptide epitope as the “predicted” epitope, in that it is predicted by analysis of the peptide inserts from strongly-binding phage clones after screening the phage displayed combinatorial library. The predicted epitope is a consensus motif, revealing which amino acids are most likely present at each position. The consensus is arrived at by analyzing many different phage clones and searching for areas of amino acid sequence homology. There is often some degree of uncertainty at one or more positions. To minimize the uncertainty and maximize the consensus, this step is best performed under high stringency phage selection conditions. In our experience, high stringency selection yields the most accurate data on the epitope's amino acid sequence. Although not explicitly shown as a separate step in FIG. 1, we discovered that by selecting for the peptides that are most immunoreactive to the selecting antibody(ies), a more accurate and informative consensus sequence results. FIG. 1 illustrates two hypothetical peptide epitopes for two different antibodies , with the amino acids arbitrarily designated with the letters A-F and L-Q.

The second step in the E-MAP process (FIG. 1) is the bioinformatic search of the protein database using the predicted epitope as an in silico probe. From our theoretical models and practical experience, individual motifs can be used to successfully query the non-redundant (nr) protein database, but only if they contain at least seven amino acids. Shorter sequences will suffice if smaller protein databases are searched. Depending on how unique the predicted sequence is, a search of the nr database may successfully retrieve a relatively short list of plausible candidates. An epitope shorter than 7 amino acids usually yields too many extraneous hits from the non-redundant protein database to be useful, especially when allowance is made for one or two mis-identified amino acids. When submitting a single epitope motif of less than seven amino acids, hundreds or even thousands of hits may sometimes result, masking the true protein match. The combined statistical power of a pairwise search, however, is sufficient to reveal (and raise the confidence in) a smaller number of plausible antigen candidates.

Requirements for Generating a Consensus Peptide Sequence Motif

In order to identify meaningful protein matches from predicted epitopes, it is important to maximize the certainty about the identity of each amino acid in the sequence. Uncertainty in the predicted epitope can inappropriately skew the content of the retrieved hit list. It also makes the assessment of potential database search results more difficult, lowering the likelihood of successfully identifying the antigen in question. Using peptide phage display [Kehoe, J., et al. Chem. Rev. (2005) 105:4056-4072.] we are essentially carrying out a casting process on a molecular scale. We are filling the antibody's binding site (the “paratope”) with random oligopeptides, and identifying which peptide sequences are the highest affinity binders. We then reconstruct a virtual best fitting consensus motif by analyzing the commonalities of those peptide sequences. We usually find certain positions in a motif to be invariant while others may exhibit conserved substitutions. These substitutions generate uncertainty in knowing the amino acid sequence of the native protein, affecting the size of the database search hit list and potentially skewing its contents. In our experience, a consensus motif usually emerges from the data if high stringency screening techniques are used during the phage display component.

Screening the peptides for strong binders. The selected peptides that bind most strongly to the antibody are identified by high stringency screening. High stringency screening is achieved by repeated rounds of positive and negative selection followed by a selection for the peptides most immunoreactive with the selecting antibody, using an immunoassay, such as an immunoblot. Positive selection refers to selecting phage that bind to the antibody of interest. Typically, the antibody is attached to a solid phase, such as paramagnetic beads. Negative selection refers to depleting from the library those phage that bind to one or more irrelevant antibodies. This process removes phage that may bind to invariant regions of antibody, outside the paratope (antigen-binding region of the antibody).

Our preferred method of screening the peptide library is to perform two or three rounds of selection. Each round of selection represents a positive-negative-positive series of selections before amplifying the phage by transfection into E. coli. According to this protocol, the peptide library expressed in phage is mixed with paramagnetic beads coated with the desired antibody. After allowing a suitable amount of time for binding, the paramagnetic beads are collected in one end of a test tube. Irrelevant phage particles contained in the supernatant are removed. Tightly-bound phage particles expressing peptides that are immunoreactive to the antibody are then eluted (pH 2.5) and the eluate is neutralized. The eluted phage are then allowed to bind to irrelevant antibodies (negative depletion). After collecting the paramagnetic beads in one end of the test tube, the unbound phage found in the supernatant are then used for another round of positive selection. The eluate of this second round of positive selection is then used to transfect E. coli. Transfection into E. coli amplifies the number of phage present, as the phage replicate within E. coli. After amplification, the process is repeated.

Computer Modeling of E-MAP Requirements

In order to better understand the requirements for accurately identifying the correct protein from an epitope, we first tested two variables: the length of the epitope and the fidelity with which the predicted epitope matches the actual sequence in the protein database. We expected that longer epitope lengths (more information) and higher epitope sequence fidelity to the native protein (average motif conservation) will both result in a greater likelihood of obtaining a correct database match.

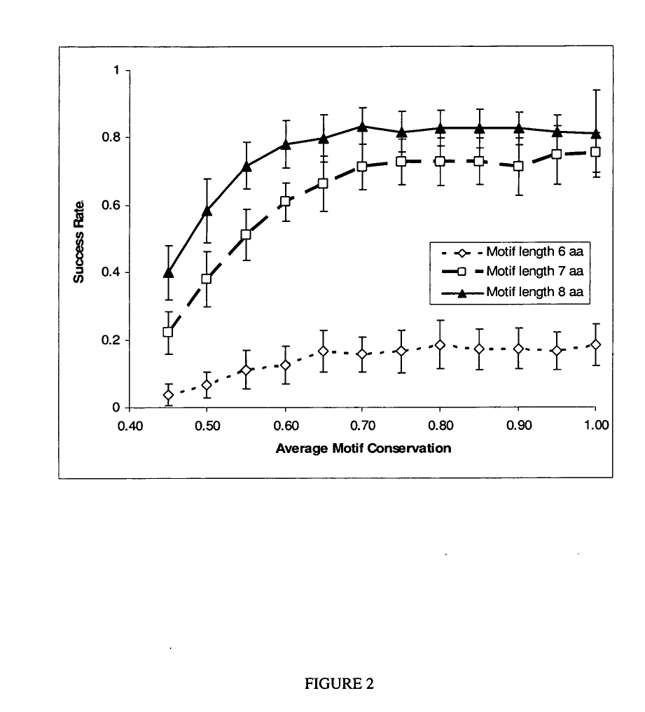

To study the relationship of epitope length and average motif conservation on the success rate in protein database searching, we performed an in silico experiment. FIG. 2 represents the output from a computer simulation, demonstrating the inter-relationship of epitope length and motif conservation. Each of the simulated peptide sequences had varying degrees of homology to the randomly chosen database entries. We termed each of these simulated peptides a “pseudoclone”, since the peptide sequence was not actually derived from a random combinatorial peptide library phage clone. For FIG. 2, the average motif conservation shown on the x axis is the proportion of homologous amino acids between each pseudoclone and the corresponding actual native sequence.

The pseudoclones were then run through the MEME and MAST bioinformatic algorithms, searching the non-redundant protein database, and scored for the predicted epitope's ability to identify the target protein. The “success rate” (y axis in FIG. 2) is the frequency with which the correct match showed up among the top ten protein database search results. FIG. 2 illustrates that, for any given average motif conservation, longer epitopes are more likely to yield a correct match from a protein database search. Such a result is expected, since longer epitopes provide more information with which to better focus the database search. For example, an eight amino acid peptide epitope with a 0.6 average motif conservation has approximately an 80% likelihood of obtaining a successful match. By contrast, a six amino acid peptide epitope with a similar average motif conservation has only approximately a 10% for retrieving a correct database hit.

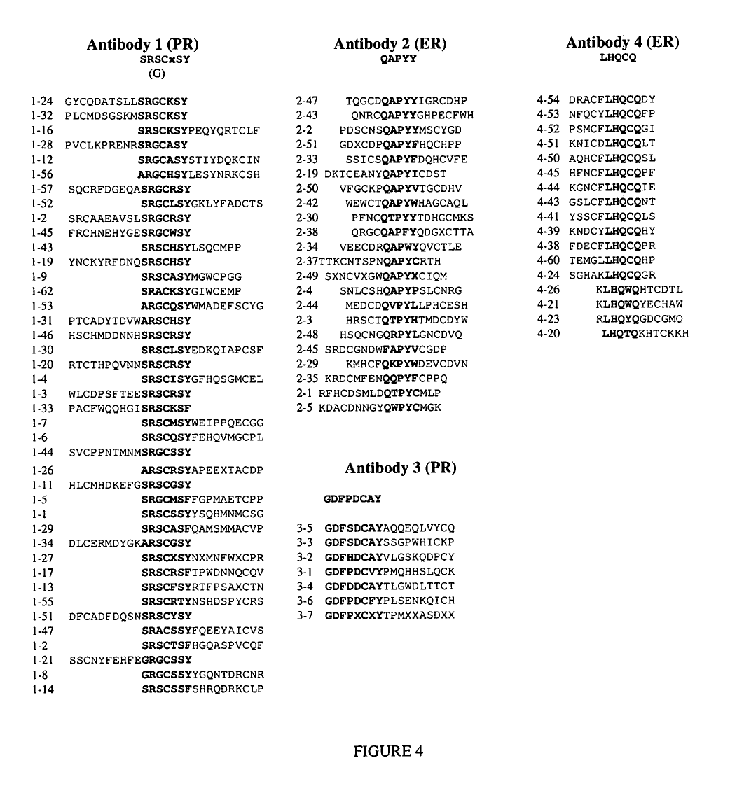

It is our experience that with high stringency screening of phage libraries followed by selection of the most immunoreactive peptides, we generally obtain 60-80% average motif conservation. Some antibodies select a narrowly-defined range of phage clones with an average motif conservation towards the higher end of that range, such as described in FIG. 4, Antibody 3. Other antibodies are not as selective, requiring us to analyze a much larger number of phage clones in order to deduce a more accurately predicted consensus motif. The significance of our in silico data lies in the finding that the bioinformatics algorithms can be tolerant of potential mismatches and conserved substitutions, validating the use of predicted epitopes as predictive search probes.

In our experience, epitope reconstruction by phage display of peptide combinatorial libraries typically yields a consensus motif four to six amino acids long. With higher stringency screening techniques, and by analyzing more phage clones, we can sometimes extend that consensus motif further. Allowing for a small degree of error in the sequence, such as conserved substitutions, the likelihood of a successful match to the protein database depends on epitope length. These in silico data (FIG. 2) also indicate that predicted peptide epitopes with length≧7 amino acids begin to have enough information so as to be capable of potentially yielding correct hits by single epitope searching of the non-redundant protein database. FIG. 2 illustrates that there is a significant difference in the predictive capability between a 6-mer and 7-mer peptide when searching the non-redundant protein database. Since most predicted epitopes are shorter than seven amino acids, single motif database searching (of the non-redundant protein database) is often unproductive. Hundreds of irrelevant close matches effectively bury, mask, and oftentimes exclude the true match from the viewable retrieved hit list. In contrast, shorter predicted epitopes, comprising 5 or 6 amino acids, can be highly productive when searching smaller protein databases. Exemplary smaller protein databases will be limited to certain organisms or categories of organisms, such as microbes. The smaller the database, the shorter the predicted sequence (also known as the consensus sequence) needs to be.

In order to maximize the accuracy and length of a consensus sequence, we have found that screening the selected phage particles for peptides that are most immunoreactive for the selecting antibody is important. The peptides expressed on phage that bind best to the selecting antibody most closely resemble the epitope in the native protein. Occasionally, consensus sequences can be generated using this method that have at least seven amino acids (e.g., antibody 3, FIG. 4). This would facilitate productive searching of the non-redundant protein database, to find an accurate match. Even with this method, many other consensus sequences will still not attain the seven amino acid threshold. If there is information on the species source of the protein, then shorter consensus sequences may still as yet be informative. Shorter consensus sequences, such as containing five or six amino acids, can be highly predictive in finding accurate matches when smaller protein databases are used, such as the protein database limited to microbial proteins. For searching the non-redundant protein database, if short predicted epitopes have insufficient information content to yield accurate hits on their own, they can still be highly predictive in the context of pairwise searching. Thus, the strength of pairwise analysis is that it can reveal previously unknown targets or further corroborate proteins identified from longer motifs.

One surprising finding from our simulation model, illustrated in FIG. 2, is that, as the average motif conservation passes 0.7-0.8, the success rate reaches a plateau. We had initially expected a linear response. However, the simulation demonstrates diminishing returns as all the predicted epitopes reach a 0.7-0.8 average motif conservation. The plateaus indicate that past a certain average motif conversation, the resulting output achieves the same (maximal) success rate, indicating similar predictive behavior in the searches. We believe this is because with an average conservation of 0.8, each pseudoclone contains a single mismatch, but the information compiled in the aggregate output from the entire set of 20 pseudoclones averages out the mismatches and achieves a near-maximal weighted representation of the “ideal,” i.e. native, motif. For this reason the predictive ability plateaus at an average motif conservation of 0.7-0.8. This finding is important, since any one particular phage clone usually does not contain an exact sequence match to the native protein. Thus, one reason E-MAP is tolerant of errors in the sequence is because they average out after analyzing many phage clones.

The details of how we generated the aforementioned model data are described in the following three sections, entitled “sequence generation”, “single motif searches”, and “multiple motif searches”:

### EXAMPLES

Sequence Generation. To generate sets of sequences for computer analysis, short sequences of predefined length N were selected randomly from the NCBI nr (non-redundant) protein sequence database. These sequences were then used to construct a position specific scoring matrix (PSSM), with the degree of residue conservation at each position perturbed by a Gaussian function around the average conservation, C. These matrices were used to generate 20 “pseudo-epitopes” (mock phage clone peptide inserts), also termed “pseudoclones.” The pseudoclones contained the epitope motif at random positions within a 20-mer, flanked by randomly generated residues. Therefore these pseudoclones contained combinatorially-scrambled motifs, each with varying degrees of sequence conservation relative to the chosen native protein epitope sequence, but on the whole approaching the defined average conservation when looked at as a group.

Single Motif Searches. For each target epitope, sequences were generated as described above. These pseudoclone sequences were used as an input to the motif searching tool MEME [Bailey, T. L., et al. J Steroid Biochem Mol Biol. (1997) 62:29-44.]. The MEME output motif was then given to MAST [Bailey, T., et al. Bioinformatics. (1998) 14:48-54.], which was used to search the non-redundant (nr) database. Success was defined as recovering the original protein sequence within the top 10 MAST database hits. The above-described test was performed 40 times for each value of N and C. These success rates were averaged over 40 runs to obtain an average and standard deviation.

Multiple Motif Searches. To generate the success rates for two motifs in a pairwise search, proteins were randomly selected from the non-redundant (nr) database and random spans were chosen as target epitope sequences. For each protein, two non-overlapping epitopes of lengths 5-8 amino acids were randomly chosen from the nr database. Each epitope was used to generate pseudoclones (as described above) which were then processed with MEME. Both MEME motifs were then given to MAST. The average success rate and standard deviation were calculated as for the single motif searches.

From this analysis, we learned that in searching the non-redundant (nr) database, there is an inflection point at seven amino acids. Consensus motifs at or longer than seven amino acids have a much higher probability of success in finding the true protein target as compared to motifs shorter than seven amino acids. We can do this by finding better ways to generate the consensus motif, such as using high stringency screening, selecting only those phage clones expressing peptides that are most immunoreactive. Shorter consensus sequences, comprising five or six amino acids, may suffice if smaller protein databases are searched. Another method to surmount the threshold of seven amino acids is to use a pairwise bioinformatic search strategy.

Pairwise Epitope Submission: Conceptual Framework

Pairwise epitope submissions to the protein database dramatically increase the statistical power of a search, beyond what is possible with a single epitope. Querying two motifs simultaneously asks which proteins contain both predicted epitopes. From a clinical standpoint, it may require that a particular disease is caused by a single antigen, or a limited repertoire of antigens, in at least a group of patients. As a consequence, there are two or more antibodies to a target protein antigen in a patient sample, both of which will provide information about the protein's identity. In practice, one often cannot be certain that pairs of antibodies from patient sera are, in fact, directed to the same target. This problem can be surmounted as described later.

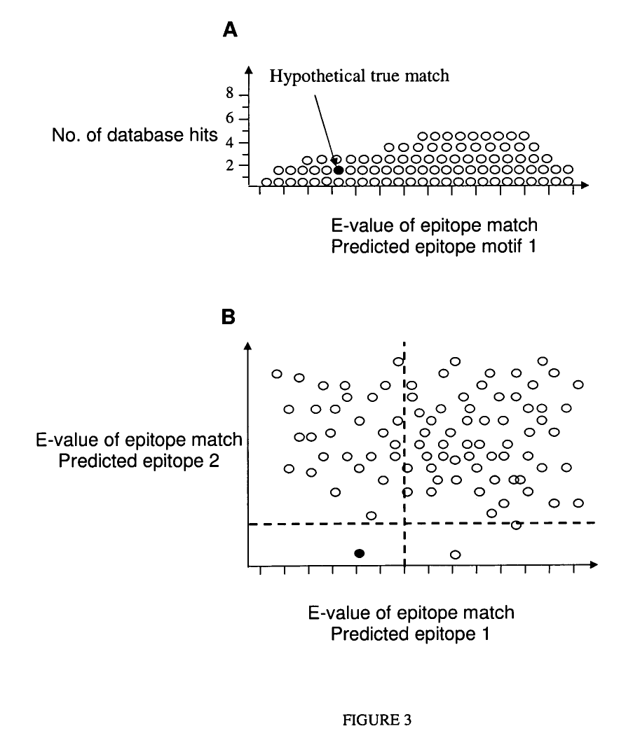

The conceptual underpinning for pairwise submission and how it is distinguished from single epitope searches is illustrated in FIG. 3. In a single epitope search with a typical 5-mer peptide epitope, many hits result. These hits can be ranked according to their expectation (E) value. The E-value can be thought to represent the closeness of the database search result to the peptide motif used for searching. It is the expected number of sequences in a random database of equal size that would match the motif(s) at least as well as the search result. For example, an E value of 10 means that one would expect, by random chance, 10 search results in a particular database to match at least as well as the search result in question. Lower E values indicate a closer match.

FIG. 3A is a stacking graph, with each database hit represented as a circle. The hits are distributed along an x axis, based on their E value. Better matches to the predicted epitope from the non-redundant protein database are to the left side (low E values). The figure also schematically illustrates that one of the database search results is the actual matching protein (filled circle) to which the antibody is directed. The true match may not have the lowest E value, if the predicted epitope is slightly incorrect. If the predicted epitope is a 5-mer, then there may be dozens or even hundreds of hits with E values equal to or better (lower) than the true match, making it impossible to distinguish the latter from irrelevant matches (open circles).

A pairwise search provides the needed discrimination to correctly prioritize a database search result. FIG. 3B is a scatter plot of the retrieved hit list of proteins containing both epitopes and whereby each hit is plotted according to the respective E values of either motif. The statistical power of the concurrent presence of both motifs allows one to screen with higher threshold stringency, and populate a shorter hit list. The true match in the database will be among those hits close to the origin of the axes, i.e. with a low combined E value for both motifs.

We tested this hypothesis in silico, measuring the success rate for a pairwise submission strategy. The average motif conservation was held constant at 0.7, a typical figure in our experience for high stringency phage display screening. The results are listed in Table 1. Unlike single motif submission, the combination of two motifs with lengths 5-6 amino acids now becomes highly predictive (67-87% success rate). This success rate is in contrast to the expected result if each motif is searched individually (≦15% success rate).

TABLE 1
Pairwise submission analysis with predicted epitope probes.

| | |
|---|---|
| | Motif 1 length |
| Motif 2 | (# of amino acids) |

| length | 5 | 6 | 7 | 8 |
|---|---|---|---|---|
| 5 | 0.669 | 0.837 | 0.872 | 0.885 |
| 6 | | 0.875 | 0.879 | 0.888 |
| 7 | | | 0.892 | 0.898 |
| 8 | | | | 0.906 |

To test the E-MAP methodology, we used a model system relating to two proteins—the human estrogen and progesterone receptors. We investigated whether we could identify these proteins by running through the epitope prediction protocol and bioinformatic algorithm (as summarized in FIG. 1). Even though we knew the antigen in this first test, we treated the specificities of the antibodies as unknowns for this initial study. Our goal for this first test was to determine if we could identify the antigens solely on the basis of the predicted epitope sequence data and bioinformatic analysis.

Predicted Epitope Identification

We tested these theoretical predictions using monoclonal antibodies to the steroid hormone receptors human estrogen and progesterone receptors. The antibodies were attached to paramagnetic beads and used for biopanning experiments. Monoclonal antibodies 1 and 3 bind to human estrogen receptor whereas antibodies 2 and 4 bind to progesterone receptor. These antibody specificities were chosen arbitrarily, since they were already in the lab and well characterized. We have no reason to believe that the results would be materially different had we chosen alternative antibody protein targets.

Several different phage libraries were employed, all encoding for random peptide inserts near the amino terminus of the cpIII M13 protein. The libraries contained six, eight, ten, eleven and twelve amino acid variable inserts in a constrained ring formation created by disulfide-bonded flanking cysteines. More recently, we are using linear libraries so as to avoid the additional uncertainty created by the invariant cysteines required for cyclic peptides. Details of the phage libraries and selection of phage (biopanning), DNA sequencing, and protein translation are known in the art of phage display, and summarized in the following three sections, entitled “phage-display libraries and biopanning”, “DNA insert sequencing”, and “protein translation”:

Phage-Display Libraries and Biopanning

Phage libraries contained rationally designed random combinatorial libraries of peptide sequences inserted into the N′ terminus of the pIII minor coat protein of the M13 bacteriophage. The cyclic 6-mer and 10-mer libraries contained two conserved cysteine resides separated respectively by four or eight amino acids. The cysteines formed a disulfide bridge, creating a conformationally constrained ring. [McLafferty, M., et al. Gene. (1993) 128:29-36.] Trinucleotide-mutagenesis technology, involving controlled polymerization of preformed trinucleotides, was used to diversify the amino acids within the ring and three amino acids on either side of the ring, allowing all amino acid types (except cysteine) with equal frequency. [Virnekas, B., et al. Nucl. Acid. Res. (1994) 22:5600-5607.]

Phage selection by biopanning. The libraries were enriched for binding to antibodies by biopanning using standard methods [Smith, G., et al. Chem. Rev. (1997) 97:391-410.] with a few modifications. Briefly, paramagnetic beads coated with anti-mouse IgG (Dynabeads; Dynal Corp., New York, N.Y.) were prepared by mixing either the ER- or PR-specific mouse mAbs (for positive enrichment) or the polyclonal mouse IgG (for negative depletion) and incubating overnight at 4° C. on a rotator. Antibody-adsorbed Dynabeads were washed five times with phosphate-buffered saline containing 0.05% Tween-20 (PBS-T) and twice with PBS before use in biopanning of phage libraries. A cyclic 6-mer or cyclic 10-mer phage library containing 10¹¹-10¹² plaque-forming units was negatively depleted by incubation with Dynabeads (100 μL) coated with polyclonal mouse IgG for 1 h at room temperature on a rotator. This negative depletion step removes phage that may bind to constant regions of mouse IgG. The unbound phage (supernatant) were then positively selected on the (ER or PR-specific) target mAb-adsorbed Dynabeads. The phage library was incubated with the mAb-coated beads for 2-3 hours on a rotator.

The beads were washed 10 times with PBS-T and three times with PBS to remove nonspecifically bound phage. Phage particles that bound to the mAb-coated beads were eluted with 0.1 mol/L glycine-HCl (pH 2.2) containing 1 g/L bovine serum albumin (BSA). The recovered eluate was neutralized with 1 mol/L Tris-HCl (pH 9.0). To ensure that the bound phage were completely eluted, the beads were treated a second time with elution buffer and the eluate was neutralized. The two eluates were pooled. The eluted phage were amplified and used in a second round of biopanning. After two rounds of positive selection, Escherichia coli were infected with the cultured phage and grown on agar plates.

DNA Insert Sequencing

Phage clones that had high specific immunoreactivity for the selecting antibody were submitted for further analysis, by sequencing the nucleotide inserts coding for the combinatorial peptides. The sequencing template was prepared by PCR amplification from an overnight phage culture. The primers used for PCR were 5-CGGCGCAACTATCGGTATCAAGCTG-3 and 5-CATGTACCGTAACACTGAGTTTCGTC-3. Thirty rounds of PCR were performed on an MJ Research Tetrad thermocycler (MJ Research, Inc.). The PCR product was diluted 1:20 with distilled H₂O. Sequencing was performed in both the forward and reverse directions with the following primers: 5-GATAAACCGATACAATTAAAGGCTCC-3 and 5-GTTTTGTCGTCTTTCCAGACGTTAG-3. ABI Big Dye™ (Ver. 1.0) was used to perform a 5-μL sequencing reaction [2 μL of Big Dye, 1 μL of distilled H₂O, 0.5 μL of primer (at 3 pmol/μL), and 1.5 μL of diluted PCR product]. The samples were then cycled for 45 rounds on an MJ Research Tetrad thermocycler. After cycling, 2.5 volumes of absolute ethanol were added, and the mixture was centrifuged at 1850×g for 30 min. The plates were inverted over paper towels, and then centrifuged at 100×g for 30 min The samples were resuspended in 5 μL of distilled H₂O and detected on an ABI 3700 DNA Analyzer.

Protein Translation

The determined nucleotide sequences of the inserts were translated in silico using the Translate tool from ExPASy Proteomics Server of the Swiss Institute of Bioinformatics (SIB) web utility available at (http://ca.expasy.org). The translated protein sequences could be verified to be in frame by identification of invariant elements of the cpIII protein and the hallmark presence of the invariant cysteines (in the cyclic peptides).

E-MAP Validation Results with ER and PR Monoclonal Antibodies

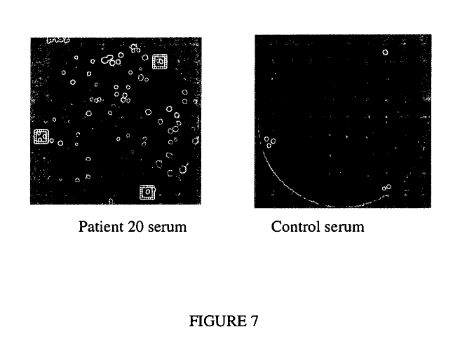

After two rounds of biopanning, we found moderate sequence variability in the peptide inserts when sequenced phage clones were selected at random (data not shown). We found that when the second round phage clones were then screened on the basis of high affinity binding to the selecting antibody, the sequence variability decreased. The peptide insert amino acid sequence from each phage clone is shown in FIG. 4. Stated in other words, a post-biopanning selection method, such as an immunoblot or ELISA, helps to quantitatively grade individual phage clones, identifying the highest affinity phage binders. We selected the most immunoreactive phage clones by creating plaque lifts and immunoblotting with the monoclonal antibody used for positive selection. We found that sequencing only the most immunoreactive second or third round phage clones resulted in greater concordance and accuracy in defining the consensus motif sequence. An exemplary immunoblot, albeit from a different context, showing immunoreactive phage clones, is shown in FIG. 7. A control blot, whereby the phage clones are incubated with an irrelevant antibody, is also shown. The method for post-biopanning selection (using phage immunoblots) is described in the following section.

Post-biopanning screening of phage clones to identify strongly binding peptides Replicate plaque lifts were created by laying nitrocellulose membranes onto the aforementioned agar plates, at 4° C. for 1 hour. The membranes were marked for orientation, carefully lifted from the agar, and placed at 65° C. to dry for 5 minutes. The membranes were then blocked with 5% non-fat dry milk in TBST (Tris-buffered Saline with 0.5% Tween-20) and then rinsed twice with TBST alone, without milk The selecting (ER- or PR-specific) mAb was prepared in TBST (2.5 mg/L) and placed on the membrane for 2 hours at room temperature or at 4° C. overnight. The membranes were then washed eight times with TBST and incubated with anti-mouse-IgG-Horseradish peroxidase (HRP) conjugate (Sigma Chemical Co., St Louis, Mo., 1:5000 dilution) for 1½ hours. A chemiluminescence protocol was used to visualize patterns of immunoreactivity (ECL Western Blotting Detection Reagents, Amersham Biosciences). Developed films were oriented to the corresponding agar plates by the markings we had made. The most immunoreactive spots (representing distinct plaque colonies) were picked and grown for further analysis. A second replicate lift was usually obtained and worked up in like manner as a control, testing non-specific immunoreactivity of the phage clones to mouse polyclonal IgG (representing the negative control).

Data Analysis from ER and PR Antibody Test

Analysis of Strongly-Binding Peptides so as to Identify the Consensus Peptide Sequence.

We used the MEME (Multiple Expectation-maximization for Motif Elicitation) software utility to identify motifs in the sequenced peptide inserts. [Bailey, T. L., et al. J Steroid Biochem Mol Biol. (1997) 62:29-44.] The program was instrumental for generating standardized and systematic motif determinations. MEME considers the relative presence of amino acids at each position of the emerging dominant motif. This leads to the creation of a consensus motif profile, capturing each phage clone's sequence information in a position-specific scoring matrix (PSSM), a two dimensional numeric array. The profile is, in essence, a virtual mimotopic array of the peptides that bind to the antigen-binding site of the antibody (the “paratope”). Using such a profile in a bioinformatic search offers distinct advantages. Instead of searching with a single “best-guess” query representing the dominant motif, the queried profile considers a larger number of combinatorially weighted sequences, averaging around the dominant motif.

FIG. 4 shows the peptide sequences that were entered into MEME and the identified motifs at the top. MEME rank orders each individual phage clone peptide insert by its similarity to the consensus motif.

Due to the stringent phage panning selection process, the individual phage peptide inserts had a high degree of consensus. The average positional conservation of each motif ranged from 73.25-95.2%. Even though there was a high degree of homology amongst the individual peptides, the derived consensus peptide sequence is not always an exact match to the native epitope. For example, the consensus motif for the Antibody 1 is SR(S/G)CXSY, where SRSCXSY is the main motif and SRGCXSY is a secondary sequence. The corresponding sequence in the native protein is ARSPRSY. For the first position, the alanine (A) in the native sequence is replaced with a serine (S) in our predicted epitope, a conserved substitution. The cysteine (C) in the predicted epitope is erroneous, but that is not altogether surprising since it is an invariant amino acid, necessary for peptide cyclization. Nonetheless, the cysteine cannot be automatically discounted since the native sequence may, in fact, have a cysteine. The “X” in the predicted epitope means that we could not identify the arginine (R) in the native sequence from our sequence data.

The consensus motif of the second antibody epitope (Antibody 2) was predicted to be QAPYY (FIG. 4). This is a close but not exact match to the native sequence QVPYY in the human estrogen receptor. Alanine (A) and valine (V) are conserved amino acid substitutions. The search program (MAST) will count conserved substitutions as a partial match.

Analysis of the third antibody determined the consensus motif to be GDF(P/S)DCAY, corresponding to a native sequence of GDFPDCAY. In this case, the invariant cysteine forced the selection of phage clones containing the relevant peptides anchored around its position. There was an exceptionally high degree of concordance amongst the sequences of the individual clones, obviating the need for further analysis of other phage clones.

The fourth antibody's predicted sequence, LHQCQ, was close to the native sequence LHQIQ. Again, the difference is due to the invariant cysteine (C) being substituted for isoleucine (I) in the native sequence. With these predicted epitopes, we identified the likely corresponding sequences in the native protein. We then tested our predictions by determining if the monoclonal antibodies bind to peptides from the native sequence. In each case, the monoclonal antibodies were immunoreactive with their corresponding peptide fragment. [Sompuram, S., et al. Amer. J. Clin. Pathol. (2006) 82-89.] With these predicted epitopes in hand, we then asked if we could have deduced the correct protein from a protein database search using single or pairwise searches.

Identification of Antigens from the Non-Redundant Protein Database.

We used the MAST (Motif Alignment and Search Tool) utility [Bailey, T. L., et al. J Steroid Biochem Mol Biol. (1997) 62:29-44.] to perform single and pairwise motif searches against the non-redundant (nr) protein database. The pairwise submission finds proteins containing both predicted epitopes. The retrieved hits are ranked according to their combined p-value, which evaluates the two epitopes' degree of maximal homologous alignment to the database entry. In this way the algorithm creates a ranking system with stringent matching criteria. [Bailey, T. L., et al. J Comput Biol. (1998) 5:211-21.] The methods for bioinformatic searching are described in the following section, entitled “bioinformatic searching method”.

Bioinformatic Searching Method

The variable regions of the inserts were transcribed into the FASTA form and submitted to MEME (Multiple Expectation-maximization for Motif Elicitation), available at http://meme.sdsc.edu/meme/intro.html). The MEME output contains the submitted peptides rank-ordered for the presence of the dominant motif determinants.

Single motif searching. To carry out bioinformatic searches using a single consensus motif, the PSSM was submitted to the MAST (Motif-Alignment and Search Tool) utility, available at http://meme.sdsc.edu/meme/intro.html, to be searched against the nr (non-redundant) protein database while allowing a maximal E-value (expectation value). The first 500 hits were then screened for the presence of the known target. Alternatively, a single consensus sequence (instead of a PSSM) can also be used for database searching using the MAST or BLAST protein database search programs. Other protein databases can be searched (other than the non-redundant protein database), if there is information that allows the search to be narrowed. Alternatively, it is possible to limit the search results based on other criteria, such as the type of organism. Such limits may dramatically change the threshold requirements for successful identification of protein database matches. For example, whereas a seven amino acid homologous sequence may be required when searching the non-redundant protein database, fewer amino acids will be required if other search constraints (such as type of organism) co-exist. The specific threshold of amino acid number will depend on the circumstance, such as the size of the proteome being searched.

Pairwise motif searching. For pairwise motif searches, the PSSMs from two motifs were combined and submitted to MAST. The MAST database search program will return many hits, which can be ranked by their position p value, sequence p value, and combined p value of alignment. These terms are defined, and the program more thoroughly described, at http://meme.sdsc.edu/meme/mast-output.html. Briefly, when tentative matches are found, each is given a score, reflecting how well the motif's PSSM fits the particular span from the identified sequence. The position p value of an alignment is defined as the probability of a random span in a randomly generated sequence having a match score at least as large as that of the given motif. The sequence itself is assigned a p value which is defined as the probability of a random sequence of the same length having a match score at least as large as the highest scoring match in the sequence. MAST also assigns a combined p value, defined as the probability of a randomly generated same length sequence having sequence p values whose product is at least as small as that of the matches of the motifs to the given sequence. Based on the latter determination, an expectation value (E-value) is generated by multiplying the combined p value of a sequence by the number of database entries. The E-value can then be thought to represent the expected number of sequences in a random database of equal size that would match the motif(s) at least as well.

For most of our pairwise analyses, we set the E-value to <10 and the threshold value for motif display to p≦0.0001. Any proteins found with a qualifying E-value of <10 solely on the basis of a single motif were disqualified. Instead, we wanted to see homologous portions of both (not just one) peptides in the protein candidate identified by MAST. For the ER and PR test model, all possible pairwise combinations of the four determined motifs' PSSMs were analyzed in this manner.

Single motif search results for ER and PR antibody epitopes. Single motif searches are not generally successful, unless the epitope length is unusually long. In the single motif submission analysis against the non-redundant (nr) database, the heptamer SR(S/G)CXSY (monoclonal antibody 1, PR-specific) was unable to find PR in the first 500 hits (data not shown), demonstrating that motif length as well as sequence composition uniqueness are essential for identifying proteins. The pentamer LHQCQ (monoclonal antibody 4, ER-specific) retrieved the human estrogen receptor in positions 40 and 43, far too low to independently establish the identification. QAPYY (monoclonal antibody 2, ER-specific) also failed to retrieve the correct protein in the top 500 hits, proving again how crucial sequence composition can be.

The only apparent exception to the pattern of single motif searches was the octamer GDF(P/S)DCAY (monoclonal antibody 3, PR-specific). A search of the nr database identified the Bos taurus PR homologue as the top ranked hit, with the correct human progesterone receptor populating positions 2-9 in the hit list. Other PR homologues were also retrieved, interspersed with extraneous hits, up to rank position 19. Monoclonal antibody 3 motif's results are atypical. The fact that an 8-mer is able to independently identify the correct protein from a database search is consistent with the simulated search results described in FIG. 2. However, obtaining a long (8-mer) predicted epitope with such a high degree of sequence fidelity to the native protein is unusual. In order to better reflect a more typical, shorter, predicted epitope and demonstrate the power of pairwise submissions, we arbitrarily shortened the octamer to a hexamer by removing the two C-terminal amino acids. With a (now shortened) predicted epitope of GDF(P/S)DC, searched singly, a markedly different hit list results. Rat PR is in position 2 and the human homologues of PR are at position 26 and below. With this arbitrarily shortened predicted epitope, we would be unlikely to identify PR as the correct match.

Pairwise motif search results for ER and PR antibody epitopes. For pairwise searching, we set the expectation value (E-value) to ≦10 and the threshold value for motif display to p≦0.0001. This effectively returns hits that have high scoring alignments for both motifs.

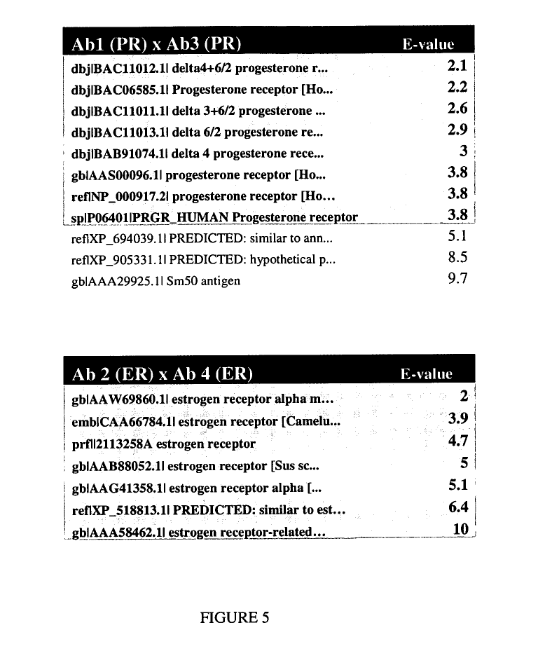

FIG. 5 shows that the pairwise submission of Antibodies 1 and 3 (progesterone receptor-specific antibodies) returned 11 hits with matches for both predicted epitopes. For antibody 3, we used a hexamer predicted epitope (rather than the octamer that we actually identified), so as to make the analysis more realistic. The pairwise submission for Antibodies 2 and 4 (estrogen receptor-specific antibodies) retrieved 7 hits with matches for both predicted epitopes. In each figure, matches that represent the correct protein or protein homologue are shaded in gray. For the PR pairwise search, the top eight database search hits are all PR or homologues. For the ER pairwise search, all of the hits within our thresholds were ER or ER homologues.

The outcomes of the database searches for single versus pairwise submissions were markedly different. Concurrent alignment of two motifs results in a more stringent database search, effectively re-ordering the hits that each motif may potentially have retrieved individually. For instance, pairwise analysis reveals SRSCXSY (Antibody 1, PR) to partially align with its true cognate target ARSPRSY, a fact not evident in the first 500 hits of the single search for this motif. In this case, SRSCXSY serves to also corroborate the tentative PR identification based on GDFPDC (Antibody 3, PR). The case was similar for QAPYY (Antibody 2, ER), whose target was not in first 500 hits when queried singly due to a single amino acid mismatch to the native sequence QVPYY. This instance is also rather remarkable in demonstrating how two short motifs (Antibody 2×Antibody 4, both pentamers with a single mismatch), which would not be expected to fare well in single searches (according to the model shown in FIG. 2), can still possess high predictive power when combined.

The pairwise motif searches (FIG. 5) are useful in generating short lists of plausible antigen candidates. They are a means to use long and short predicted epitopes to better focus the database search. When antibodies are derived from the convalescent sera of patients presenting with a distinct clinical entity, the pooled information from their predicted epitopes is likely to implicate plausible antigen candidates for further testing.

Distinguishing True from False Database Search Results.

When working with antibodies to unknown protein antigens, it is generally not possible to know, a priori, if the epitopes are actually on the same target protein. In any disease, patients may be producing many antibodies and we do not know if those antibodies are to one or many antigens. Even a single inciting microorganism may elicit antibodies to many different proteins. Some of the immunodominant epitopes may also be to conformational determinants and wouldn't be useful through this type of protein database search. An important concern in performing pairwise analysis is what might happen with pairwise submission of predicted epitopes that do not correspond to the same antigen. For E-MAP to be practical, such mismatched pairs should not yield database search results that will mislead a research investigation. This criterion is important, since pairwise searching might otherwise create an inordinately long list of false candidate target antigens. If the E-MAP technique is to be practical, then it is important to be adaptable to real-life situations where we do not know, a priori, whether the targets are correctly matched or not.

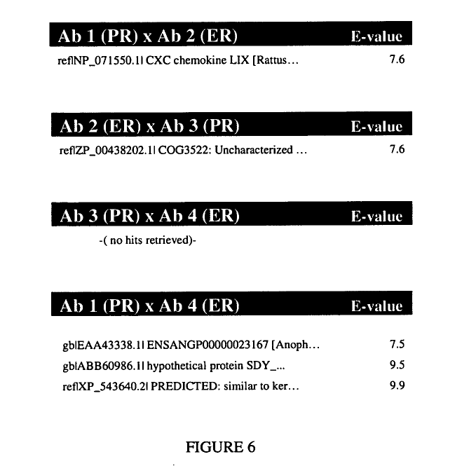

We found that inappropriate pairwise epitope searches can usually be distinguished. FIG. 6 shows the search results of four inappropriately paired predicted epitopes.

Inappropriately paired predicted epitopes result when the two antibodies are directed to different antigens, in this case between epitopes for the human estrogen and progesterone receptors. The same situation would exist if one of the antibodies binds to a conformational determinant FIG. 6 shows that there are a few database hits with these inappropriately paired predicted epitope searches when using an E-value threshold of ten. We analyzed these few hits more closely, to identify characteristics that might identify them as resulting from a mismatched pairwise search.

So far, we have two threshold criteria: the presence of both motifs in the candidate protein and a low E value (e.g., ≦10 in the examples shown.). The low E value reflects a close matching of amino acids, between the predicted epitopes and the candidate protein. In analyzing the database search results in FIG. 6, we found an additional criterion to help distinguish false from true matches. As a third criterion, a certain number of amino acids in each predicted epitope should precisely match the database entry sequence for identity. The false matches tend to have more conserved substitutions and fewer identical amino acid matches for each position. Identifying this difference can be accomplished by visual examination, comparing the search results to the predicted epitopes.

In our data set, true matches can be distinguished from false ones by the degree of identity and homology for each entry. In this context, homology is a broad term referring to the degree of similarity in two amino acid sequences, which includes both identity (the same exact amino acid) or a conserved amino acid substitution. Identity represents a closer match than a conserved substitution, which in turn represents a closer match than a non-conserved substitution. A conserved amino acid substitution is one which two amino acids, although different, still belong to the same class. A common classification method includes aliphatic amino acids (glycine G. alanine A, valine V, leucine L, isoleucine I, referring to their single letter abbreviations), non-aromatic amino acids with hydroxyl groups (serine S and threonine T), amino acids with sulfur groups (cysteine C and methionine M), acidic amino acids and their amides (aspartic acid D, asparagines N, glutamic acid E, and glutamine Q), basic amino acids (arginine R, lysine K, histidine H), aromatic amino acids (phenylalanine F, tyrosine Y and tryptophan W), and imino acids (proline P). For example, both tyrosine and phenylalanine are both aromatic amino acids.

True matches can be distinguished from false ones by applying the following qualifying criteria: (a) For a five amino acid predicted epitope, an identical match in four positions out of five positions (80% identity) will distinguish true from false matches; (b) For a seven amino acid predicted epitope, identity in 4 positions (60% identity) and homology (either identity or conserved substitution) in at least 2 more (85% overall alignment match) will distinguish true from false matches; (c) For an eight amino acid epitope, identity in 6 positions (75% identity) and homology in at least 1 more (87.5% overall) makes the distinction. Applying this third criterion to the data set in FIGS. 5 and 6 discriminates true from false matches. Search results satisfying the criteria are in bold and all of the bolded entries are correct matches. The threshold criteria for percent identity and homology of any motif will probably vary, depending on the length and sequence composition of the predicted epitope. Regardless, rank ordering the database hits along these general lines will be expected to correctly prioritize the search results. The proteins can then be evaluated as candidate antigen matches.

Summary of E-MAP Technology

Our newly described E-MAP technology is a valuable new investigative tool for uncovering the target of immune responses in various diseases. The new investigative capabilities of E-MAP may be useful for elucidating the etiology of various diseases, including B and T lymphoproliferative disorders, inflammatory diseases of unknown etiology, allergy, and autoimmunity. The only requirements for using the technique are the availability of antibodies, preferably monoclonal, and that at least some of them recognize linear epitopes. In addition, E-MAP requires that the true protein antigen, or a homologue, be present in the protein database. Pairwise searching may be equally useful in analyzing T lymphocyte targets in inflammatory diseases of unknown etiology. Unlike antibodies, the T lymphocyte receptor always recognizes linear epitopes, eliminating the drawback of unproductive searches due to antibody recognition of conformational epitopes.

An important new feature of this technology is the use of a screening step, selecting only the most immunoreactive phage binders to the selecting antibody. By including this step prior to phage clone selection, we select for phage particles expressing peptides that bind most strongly to the selecting antibody. We discovered that these peptides most closely resemble the epitope to where the antibody binds in the native protein. The screening step can be an immunoblot or other immunoassay that tests immunoreactivity of the phage particles to the selecting antibody. If the entire (non-redundant) protein database is being searched with the resulting sequence, then our predictions show that the consensus sequence must have at least seven amino acids that are homologous to the native protein. If smaller protein databases are searched, then fewer amino acids will suffice.

An important new feature of the E-MAP technology is the pairwise search analysis. This feature overcomes the statistical limitation that previously precluded finding accurate matches with most predicted epitopes. Searching the protein databases simultaneously with two, even short, predicted epitopes provides sufficient statistical power to accurately retrieve the correct protein target from the protein database. Such a pairwise motif analysis essentially “co-immunoprecipitates” the true antigen target in silico.

This pairwise analysis can yield strikingly different results compared to single search protocols currently in use. With a single epitope search, even one amino acid substitution can dramatically skew the search results. Because of this potential for error, top ranking search results from single epitope database searches may exhibit complete sequence identity in their alignment with the predicted epitope probes and still be incorrect matches. In fact, dozens or even hundreds of database hits may be exact matches or have only one amino acid substitution, depending upon the length of the predicted epitope. The longer the predicted epitope, the more unique that sequence will be, yielding fewer closely matching database search results. It is therefore difficult to critically evaluate such a large number of potential antigens and select candidates for experimental verification.

Pairwise motif analysis, on the other hand, combines the predictive power of two motifs, thereby establishing an even higher level of search stringency. The net result is the reorganization of candidate hit lists compared to single epitope searches, revealing a new set of search results with the requisite presence of both motifs appearing in declining order of relative combined alignment. Thus, E-MAP results do not independently prove that a particular protein is an antibody's target. Rather, E-MAP identifies a short list of potential protein candidates for further testing and evaluation.

In most instances, the predicted epitope is closely homologous to the eliciting epitope in the native protein. This is a testament to the power of the phage display technique that, by using a random peptide combinatorial library, provides an antibody with a staggering array of oligopeptides from which to select. By imposing high stringency selection conditions, proper phage to antibody ratios, and a post-panning immunoblot selection of individual clones, the selected phage clones' peptide inserts generally observe a tight convergence to the native protein epitope. There is always some degree of uncertainty in predicting epitopes using phage-displayed combinatorial peptide libraries. We have shown, however, that a small amount of uncertainty can be tolerated in the bioinformatics algorithms.

It is possible to narrow the search if there is information about the protein target from prior clinical investigation. The non-redundant protein database comprises the largest set of entries, spanning all species. If, for example, one has reason to believe that the protein is microbial in origin, then a more restricted database search, limited to microbial proteins, can be used to narrow the search parameters. The various protein databases have been described elsewhere [Apweiler, R., et al. Curr Opin Chem Biol. (2004) 8:76-80.] and specific subsets can be downloaded from various sources to be searched separately. With more limited searches, fewer amino acids than seven will suffice in the consensus sequence, for single epitope protein database searching. Pairwise searching will also likely yield a shorter list, with fewer irrelevant potential protein database matches, if a smaller protein database can be searched because of the availability of information limiting the protein to a particular species or group of species.

A limitation of E-MAP is that conformational epitopes will not yield matches in the protein database. Although some textbooks suggest that conformational epitopes may predominate in immune responses, we believe that this conclusion may somewhat overestimate their prevalence. Many antigens also produce humoral immune responses to linear epitopes. [Atassi, M. Z. Eur J Biochem. (1984) 145:1-20.] In fact, we previously described that the monoclonal antibodies used for clinical immunohistochemistry testing are all directed to linear epitopes. [Sompuram, S., et al. Amer. J. Clin. Pathol. (2006) 82-89.] The search tools that are currently available for epitope mapping of conformational epitopes require knowledge of the crystal structure of the protein antigen. [Schreiber, A., et al. J Comput Chem. (2005) 26:879-87.] Although antibodies to conformational epitopes do not help identify the protein target, our findings shown in FIG. 6 demonstrates that they also will likely not create many false leads. Our data indicate that searches using mismatched epitopes can largely be distinguished from true matches. At the very least, true matches tend to have lower E values, contain both epitopes, and have a closer match to the predicted epitope than false matches.

In practical terms, the E-MAP analysis process involves submitting a collection of clinically relevant monoclonal antibodies for analysis, not knowing which, if any are correctly matched to the same protein. Since we have no way to know which antibody pairs will be correctly matched, we submit all combinations in separate pairwise searches. The number of independent pairwise combinations to be performed is, in fact, manageable and calculated from combination theory, as n!/[2×(n−2)!], where n equals the number of independent antibodies being analyzed. For example, nine different antibodies results in 36 different pairwise searches.

Exemplary Application of E-MAP to Multiple Myeloma

Although there are many applications for an immunomic search technology, this immunomic search technology was of immediate interest to us for investigating the etiology of B lymphoproliferative disorders. There is growing evidence that these malignancies are triggered by antigenic stimuli. [Jack, H.-M., et al. Proc. Natl. Acad. Sci. (USA). (1992) 89:8482-8486; Friedman, D., et al. J. Exp. Med. (1991) 174:525-537; Lecuit, M., et al. N Engl J Med. (2004) 350:239-48; Sahota, S., et al. Blood. (1997) 89:219-226.] The accumulating evidence for stimulation through the B-cell receptor in clonal B-cell lymphoproliferative disorders highlights the importance of characterizing the antigenic stimuli. Identification of these antigens may illuminate the etiology of B-cell lymphoproliferative diseases and open new avenues of therapeutic intervention. However, without a clinical basis to suspect a particular antigen, as in the paradigm case of gastric MALT lymphoma and H. pylori [Parsonnet, J., et al. N Engl J Med. (2004) 350:213-5.], there is currently no method to identify putative antigenic stimuli. Consequently, we applied the E-MAP technology to this clinical question, by performing an immunomic analysis of the paraproteins found in multiple myeloma.

Multiple myeloma is a malignancy of cells in the B lymphocytic lineage that produce a monoclonal immunoglobulin, or “paraprotein”. There is no known etiologic agent for multiple myeloma, but there is growing evidence that microorganisms are important etiologic causes of other B lymphocytic malignancies. The most striking example is gastric MALT lymphoma, which has been linked to chronic H. pylori infection. [Isaacson, P. Annals of Oncology. (1999) 10:637-645; Eck, M., et al. Recent Results in Cancer Research. (2000) 156:9-18; Boot, H., et al. Scand. J. Gastroenterol.—Suppl. (2002) 236:27-36.] In that example, identification of the etiologic agent led to the use of antibiotics as a curative treatment, especially for patients with low grade lymphomas. Similarly, immunoproliferative small intestinal disease (IPSID), an uncommon form of B cell lymphoma arising in the small intestinal mucosa-associated lymphoid tissue, has been linked to C. jejuni. [Lecuit, M., et al. N Engl J Med. (2004) 350:239-48.] In other instances, B lymphomas have been described as autoreactive to an endogenous retrovirus in one case [Jack, H.-M., et al. Proc. Natl. Acad. Sci. (USA). (1992) 89:8482-8486.] or to unknown autoantigens in another. [Friedman, D., et al. J. Exp. Med. (1991) 174:525-537.] Other microbial antigenic drivers of B lymphoproliferative disorders include B. burgdorferi with MALT lymphoma of the skin, C. psittaci with MALT lymphoma of the ocular adnexa, and hepatitis C virus with splenic marginal zone lymphoma. [Fisher, S., et al. Curr Opin Oncol. (2006) 18:417-424.]

Despite these findings, there are no known microbial associations for the most prevalent B lymphoproliferative disorders. Previously established associations were initially suspected on the strength of clinical clues. For example, H. pylori had already been demonstrated to cause gastric ulcers, before it was investigated as a cause of gastric MALT lymphoma. Without clinical clues, there is no method for identifying the antigenic specificity of malignant T or B lymphocytes. In the past decade, there have been several attempts to identify antigens for multiple myeloma by probing paraproteins' antigen-binding regions (paratopes) with combinatorial peptide libraries. [Dybwad, A., et al. Scand J Immunol. (2003) 57:583-90; Szecsi, P. B., et al. Br J Haematol. (1999) 107:357-64; Thurnheer, M., et al. Eur. J. Immunol. (1999) 29:2676-83; Zonder, J., et al. American Society of Clinical Oncology Annual Meeting. (2005) Abstract 6626.] By identifying peptides that bind to a paratope, it was hoped that it might be possible to link the sequence to an entry from the protein databases. The peptide sequences that were identified were insufficiently precise or accurate to yield particularly meaningful database hits.

With E-MAP, it is possible to identify the corresponding protein antigens for antibodies, without ancillary clinical clues. E-MAP differs from previous methodologic approaches [Dybwad, A., et al. Scand J Immunol. (2003) 57:583-90; Szecsi, P. B., et al. Br J Haematol. (1999) 107:357-64; Thurnheer, M., et al. Eur. J. Immunol. (1999) 29:2676-83; Zonder, J., et al. American Society of Clinical Oncology Annual Meeting. (2005) Abstract 6626.] in at least two important ways. First, higher stringency levels are used during phage panning, resulting in a more accurate and predictive consensus peptide sequence. Also, E-MAP uses a different type of bioinformatic analysis, looking for clustering of protein database targets amongst two or more patients. We performed an E-MAP analysis on the paraproteins from nine randomly chosen patients' with multiple myeloma (MM).

E-MAP Analysis of Multiple Myeloma

A phage library with approximately 20-mer random linear peptide inserts was enriched by three rounds of panning against myeloma patients' paraproteins. Each round of selection comprised a positive selection against the paraprotein, a negative selection against normal human immunoglobulins, and a subsequent positive selection round against the same paraprotein. The eluted phage from round one were then amplified by transfection in E. coli and the process repeated. The enriched third round phage were then plated on an agar/E. coli lawn. Replicate lifts were created on nitrocellulose membranes, which were then tested against the myeloma patients' serum for immunoreactivity.

FIG. 7 illustrates representative immunoblot results (patient 20) as seen using sera from patients with multiple myeloma. A replicate blot incubated with normal (control) serum from a healthy individual without a paraprotein is also illustrated. Third round, enriched phage clones are immunoreactive with the myeloma patient serum but not with a normal serum that does not contain a paraprotein Immunoreactive phage clones were then selected, grown, and analyzed. The pxeptide inserts for each clone were sequenced and areas of similarity aligned with each other.

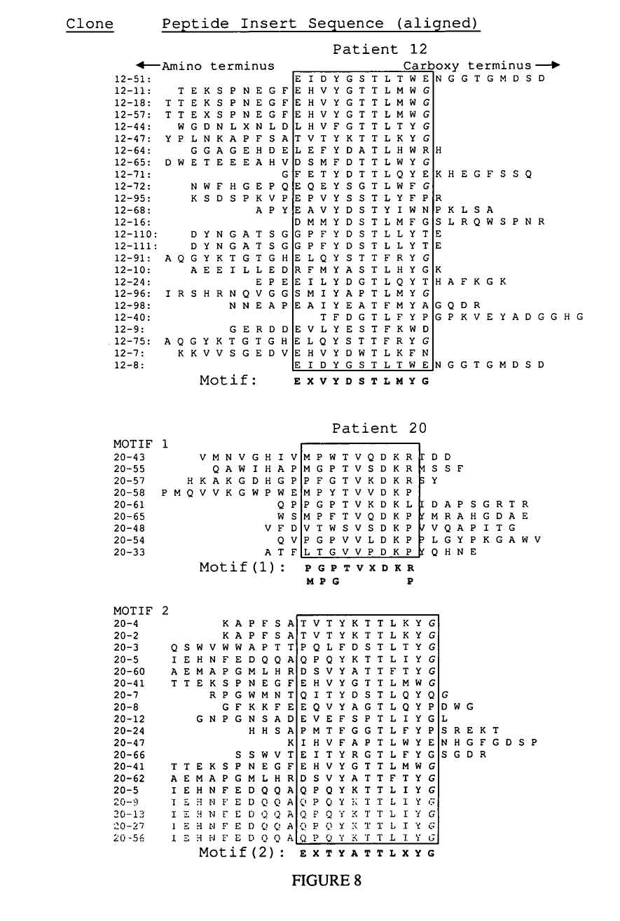

We analyzed nine patients by E-MAP, and show the sequence data from two of them—patients 12 and 20 (FIG. 8). For patient 20's paraprotein, two distinct motifs emerged, designated motifs 1 and 2 in FIG. 8. We subsequently determined that, although serum immunofixation analysis only shows one paraprotein, a second one is present below the threshold of detection using this technique. The two motifs for patient 20 represent mimotopes (peptides mimicking the epitope) for each of the two paraproteins.

For patient 20 motif 2, the fact that so many peptide stretches corresponding to the consensus sequence are immediately adjacent to the carboxy terminus (right-hand side) indicates that the next (invariant) amino acid is likely identical to the native sequence. Otherwise, the peptide stretches corresponding to the consensus sequences should have been randomly positioned within the peptide insert. For that reason, we included the next amino acid on the carboxy side (glycine, G) as part of the consensus peptide sequence. The dominant amino acid sequence for each of the two patients was derived from MEME, and is listed at the bottom of FIG. 8.

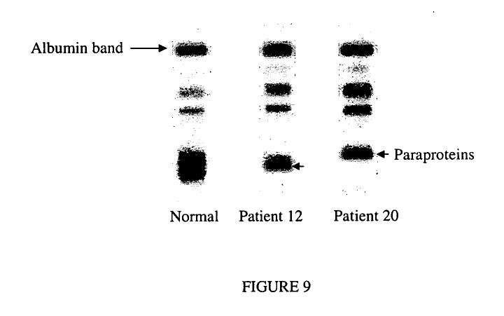

A serum protein electrophoresis gel image from patients 12 and 20 is shown in FIG. 9. A normal, healthy individual (who has no paraprotein) is also shown alongside that of patients 12 and 20. We used a commercially available serum protein electrophoresis kit. Patient sera are applied to precast protein β1/β2 agarose gels in a Hydrasys electrophoresis instrument (SEBIA-USA, Norcross, Ga.) according to the manufacturer's instructions. [Bossuyt, X., et al. Clin Chem. (1998) 44:944-999.] In this gel, the anode is located to the top. In this type of agarose gel electrophoresis, proteins are separated by charge, not size. Therefore, albumin is located towards the anode because albumin assumes a strongly negative charge at pH 8-9 (the buffer pH during electrophoresis). Paraproteins generally migrate towards the cathode. The paraproteins are monoclonal antibodies secreted by malignant cells and are denoted on the gel with arrows. The analysis by E-MAP is aimed at elucidating the antigens to which they bind.

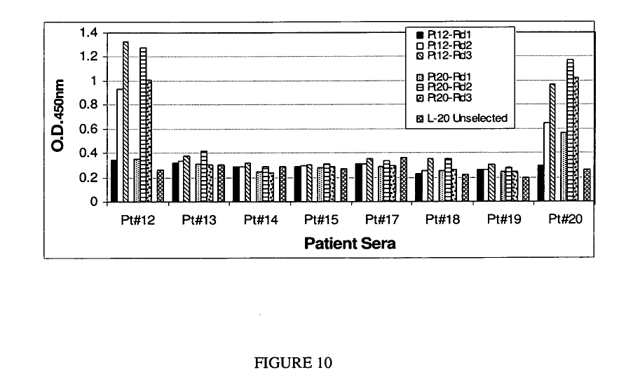

The consensus peptide sequences for patients 12 and motif 2 of patient 20 both share the amino acid sequence E-Y-T L-Y G (dashed spaces representing positions of some uncertainty). Because of the similarity, we speculated that the two paraproteins may actually recognize the same exact epitope. To evaluate this possibility, we tested phage preparations enriched to bind to one paraprotein for immunoreactivity to the other patients' serum antibodies. Namely, phage that were enriched for patient 12's paraprotein were tested for immunoreactivity against the paraprotein of patient 20, and vice versa. Several other patient sera were included as controls. FIG. 10 illustrates the results of a phage ELISA designed to test this point. Briefly, various patient paraproteins (as described along the x axis of FIG. 10) were captured onto microtitre wells coated with anti-human IgG antibody. Different phage preparations, as indicated in the legend of FIG. 10, were then allowed to bind to the immobilized paraprotein. The phage preparations included the starting library, termed “L-20 Unselected”. In addition, we tested phage preparations after 1-3 rounds of panning against patient 12's paraprotein or patient's 20 paraprotein. After rinsing off unbound phage, the relative level of phage adherence was assessed with an anti-cpVIII—enzyme conjugate followed by the enzyme substrate. Optical density, a measure of relative binding, for the various groups is indicated on the y axis. FIG. 10 shows that the paraproteins from patients 12 and 20 bind to their respective phage preparations. The relative number of bound phage increases after two or three rounds of enrichment. In addition, patient 12 and 20 sera bind reciprocally to the phage preparation panned against the other's paraprotein. Namely, patient 12's paraprotein binds to phage that were enriched with patient 20's paraprotein, and vice versa. The phage ELISA method is described in the next paragraph.

ELISA of phage Immulon-4HBX flat-bottom microtiter plates (Thermo Electron Corp; Milford, Mass.) were coated with 100 μl/well of 4 μg/mL of anti-human-IgG or anti-human-IgA (Vector Laboratories; Burlingame, Calif.) in 0.05 M carbonate-bicarbonate buffer, pH 9.6 (capsules by Sigma-Aldrich), overnight at 4° C. Unbound antibody was rinsed off and the wells were blocked with 200 μl/well of 5% non-fat dry milk in PBS, for 1 hour at room temperature. The wells were rinsed once and patient sera (as well as pooled normal control sera) were added, appropriately diluted so that the final concentration of immunoglobulins was 10 μg/mL in PBST (0.05% Tween), 0.1% milk, and incubated 2 hours at room temperature. Wells were washed 8× with PBST (0.05%). First, second and third round phage preps from each analyzed patient, as well as L-20 starting library and a phage preparation of wildtype M13 phage, were diluted 1:100 in PBST (0.1%), 0.1% milk and 100 μl/well are added and incubated overnight at 4° C. The wells were washed 8× with PBST (0.05%). Rabbit anti-fd (anti-phage) was prepared as 1:750 in PBST (0.05%), 0.1% milk and 100 μl/well and added for 2 hours at room temperature. The wells were washed 8× with PBST (0.05%). Goat anti-rabbit-Alkaline Phosphatase was prepared as 1:750 in PBST (0.05%), 0.1% milk and 100 μl/well were added for 2 hours at room temperature. One of ordinary skill will understand that any antibody-enzyme conjugate, where the antibody is directed to the M13 phage, will suffice in this assay. The wells were washed 8× with PBST (0.05%) and then 100 μl/well of alkaline phosphatase substrate (1 mg/mL, tablets, Sigma Chemicals; St. Louis, Mo.) was added. The absorbance at the appropriate wavelength (depending upon the enzyme and substrate used) and was read on a Bio-Rad Model 2550 EIA Reader instrument.

Since the sequence data for patient 12 and motif 2 of patient 20 (FIG. 8) relate to the same epitope, we combined the two data sets and re-analyzed the aggregate data by the MEME software utility. We have previously demonstrated that, for linear epitopes, the predictive power of two independent antibodies is superior to just one. Incorporating the information content from two epitopes provides greater information content and leads to better accuracy in predicting the native protein. The resulting dominant motif for the combined data sets is EXVYDTTLXYG. Epitope motifs with length≧7 amino acids can be used to successfully interrogate the protein database and identify accurate candidates. The predicted epitope of these two paraproteins is sufficiently long (11 amino acids) so that it exceeds that threshold. We decided to submit two different types of database queries, employing MAST or BLAST search algorithms.

MAST is capable of accepting the MEME analysis motif output in the form of a two-dimensional numeric display, the Position-Specific Scoring Matrix (PSSM). The latter is not simply a dominant motif string, but contains all of the phage clones' peptide insert information, preserving the experimentally-observed positional variation within the span of the determined motif. This results in a profile of a virtual mimotopic array of peptides. Matches are rated on exactness of fit and then scored for probabilities of occurrence based on accepted bioinformatics models. The better the fit, the higher the rank order of the retrieved hit.

We submitted the combined PSSM of patient's 12 and 20 to MAST, searching against the non-redundant (nr) protein database, having set a threshold expectation (E) value of 50. We retrieved 61 hits, 41 of which were entries for the glycoprotein B of human cytomegalovirus (HCMV), beginning at position 11. Discounting multiple entries for the same protein, we retrieved 15 distinct proteins. Aside from glycoprotein B, the remaining 14 were all entries for conceptual translations afforded by various sequencing projects. We scrutinized all of the hits for the number of amino acids demonstrating identity with our 9 well characterized positions. Only 4 hits exhibited identity in 7 out of the 9 positions, and out of those only glycoprotein B had maximal coverage for all 9 when conserved substitutions were considered.

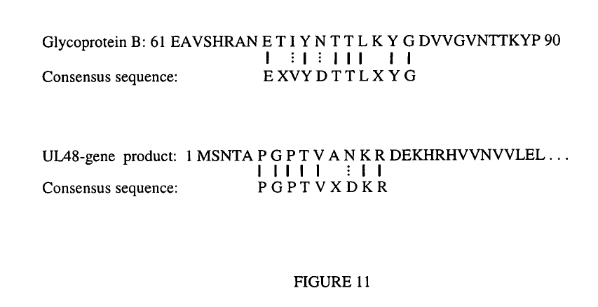

We also submitted the dominant motif string (EXVYDTTLXYG) to the National Center for Biotechnology Information (NCBI)'s “search for short, nearly exact matches” protein-protein BLAST utility (http://www.ncbi.nlm nih gov/BLAST/). This allowed us to better lock in the amino acid identity for the predicted epitope's positions. Even though conserved substitutions would be considered, there was no PSSM introducing further laxity in defining the positions. We searched against the nr database, using default settings (PAM 30 matrix, word size 2 and expectation value 2000), requesting the top 100 hits. Glycoprotein B populated positions 2-66 of the search. The top ranked hit was a protein predicted to be similar to the zinc finger protein 539 from Pan troglodytes. However, this top ranked hit failed to exhibit the maximal alignment achieved with HCMV Glycoprotein B. All in all, the predicted epitope achieved a 63% (7/11) identity and 81% (9/11) overall homology with glycoprotein B. FIG. 11 compares the predicted epitope with the native sequence of glycoprotein B. The predicted valine (V) in position 3 is actually an isoleucine (I) in the native sequence, and the predicted aspartate (D) of position 5 is actually an asparagine (N). BLAST correctly identified these as conserved substitutions.

We also performed a similar analysis for motif 1 of patient 20. This search identified the UL-48 gene product of human cytomegalovirus as a leading candidate. The degree of homology is shown in FIG. 11.

HCMV Immunoreactivity Assays

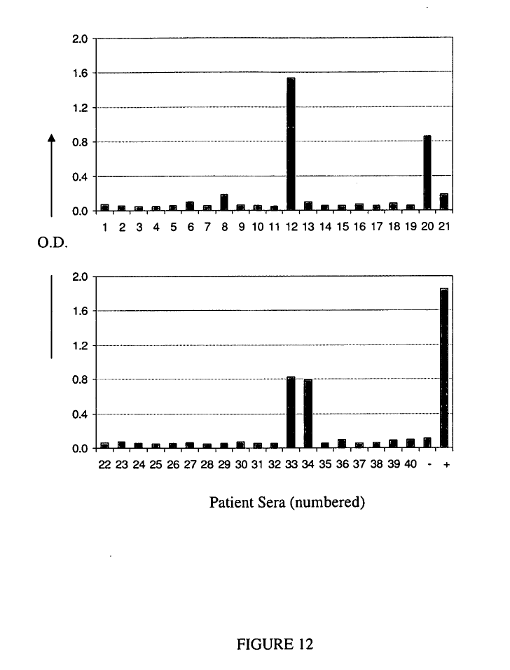

HCMV Glycoprotein B ELISA. Since glycoprotein B of human cytomegalovirus so closely aligned with the combined consensus peptide sequence from patients 12 and 20, we tested whether it is, in fact, the antigen. Sera from forty different myeloma patients were tested for immunoreactivity to the AD2 domain of glycoprotein B in a commercial ELISA kit (Biotest, Dreieich, Germany). In this kit, the antigen is a fusion protein derived from the UL55 reading frame of HCMV glycoprotein B, strains AD169 and Towne. FIG. 12 illustrates that of the forty myeloma patients' sera tested, four were highly immunoreactive. As predicted by the E-MAP data, both patients 12 and 20 were immunoreactive. These data confirm our E-MAP-derived prediction that HCMV is the target of the patients' paraproteins.

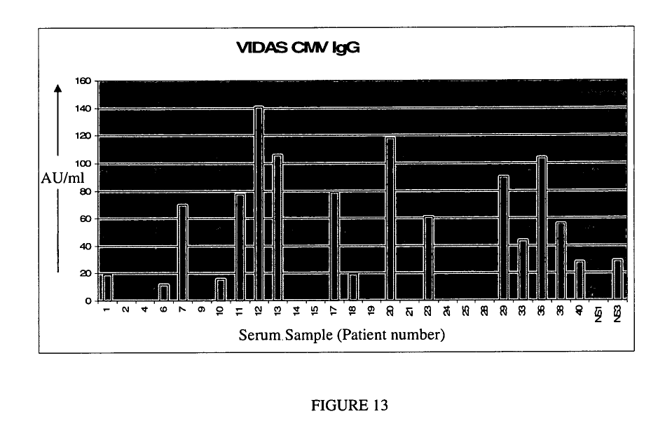

HCMV Lysate Immunoassay. These findings were also confirmed in a different commercial assay (“VIDAS”), marketed by bioMérieux, Inc., Durham, N.C. Rather than testing for immunoreactivity to a purified HCMV recombinant glycoprotein B, the VIDAS assay tests for immunoreactivity to a HCMV lysate, which is immobilized onto a solid phase. Thus, the lysate is able to test for a greater array of different antibodies to various HCMV proteins. This particular assay detects IgG antibodies to HCMV with a monoclonal anti-human IgG-alkaline phosphatase conjugate. FIG. 13 is a graph of the data from a collection of multiple myeloma patients. The y axis is “AU/ml”, which stands for arbitrary units per milliliter of serum. Arbitrary units are used because of the absence of international units. As before, patients 12 and 20 are immunoreactive, along with a number of other multiple myeloma patients. Because of the high concentration of paraproteins, these samples are diluted out ten-fold more than is usual and recommended by the manufacturer. Therefore, the actual AU/ml is ten-fold higher than shown. Patient samples “NS1” and “NS3” are normal sera (non-myeloma) chosen randomly. One of them (NS3) has a low titer to HCMV. This assay result again supports the conclusion predicted by the E-MAP method.

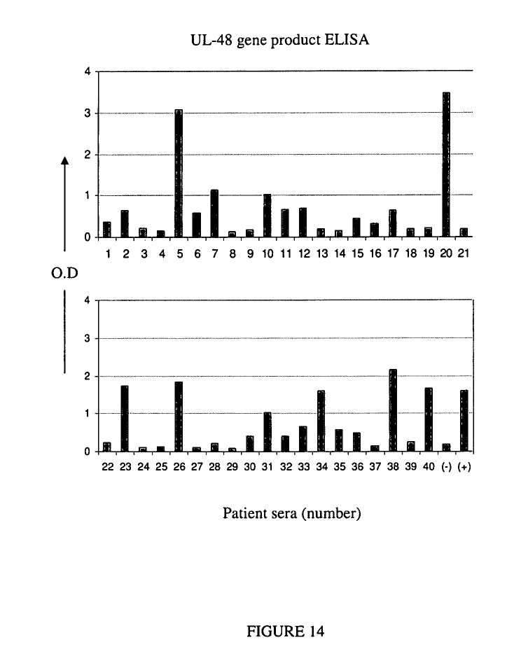

UL-48 Gene Product ELISA. The same forty MM patients as tested for immunoreactivity to glycoprotein B were also tested for immunoreactivity to the N-terminus (amino acids 1-20) of the UL-48 gene product. Patient 20's serum sample yielded the strongest signal, confirming the immunoreactivity that was predicted by E-MAP analysis (FIG. 14). Even at a 1:250 dilution, the color intensity from patient 20 is off-scale. Numerous other MM patients are also seropositive, suggesting that the UL-48 gene product may be amongst the more immunogenic proteins synthesized by HCMV.

Patient 20 has Two Serum Paraproteins

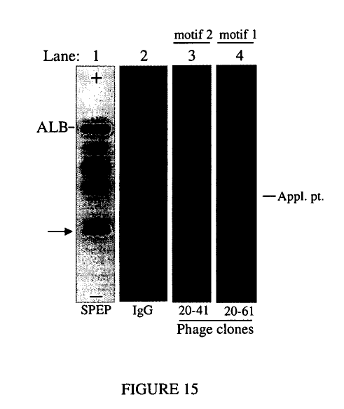

We were surprised that patient 20's E-MAP analysis produced two different motifs, since serum protein electrophoresis (SPEP) from patient 20 revealed a single paraprotein (FIG. 9), without background polyclonal immunoglobulins. Background polyclonal immunoglobulins are usually suppressed in the context of multiple myeloma. A more sensitive immunoblot, however, reveals the presence of other immunoglobulins but at lower than normal concentrations (FIG. 15, lane 2). The background polyclonal antibodies appear as a smear in the IgG lane (lane 2), since each antibody is slightly different than the next. Therefore, each has a slightly different net charge and, consequently, migrates differently on agarose gel electrophoresis.

FIG. 15 illustrates three different types of electrophoretic staining. In the “SPEP” lane, amido black is used to cause serum proteins to become visible. In the IgG lane, an immunodetection protocol using antibodies to human IgG results in the coloration of human IgG antibodies, rendering them visible. In the lanes probed with phage clones 20-41 and 20-61, serum antibodies are visualized that bind to each of these respective phage clones. As can be seen through this example, a variety of different serum antibodies can be visualized by different types of chemical or immunologic staining.

To sort out the source of the two motifs associated with patient 20, we performed a phage immunoblot experiment (FIG. 15). As probes, we used purified phage clones that express peptides from each of patient 20's two motifs. In this assay, the phage clones representing each motif bind to their respective serum paraproteins. Replicate lanes of the nitrocellulose membrane were probed with different phage clones, expressing peptides corresponding to either motif 1 (phage clone 20-61, representing the UL48 gene product motif, lane 4) or motif 2 (phage clone 20-41, lane 3, representing the AD-2S1 epitope of glycoprotein B). FIG. 15 illustrates that the two phage clones bind to different monoclonal immunoglobulins of patient 20, migrating to distinct gel positions. Clone 20-61 (motif 1, having the UL48 sequence) co-migrates with the dominant paraprotein. Phage clone 20-41 (motif 2, having the glycoprotein B sequence) binds to a doublet band that represents a separate monoclonal immunoglobulin in serum. The doublet probably represents monomer and (non-covalently associated) dimer forms of the same paraprotein, a frequent occurrence in serum protein electrophoresis. Therefore, patient 20's two consensus peptide sequences are associated with two distinct paraproteins, only one of which is detectable by SPEP. Patient 20's minor paraprotein can be visualized by the more sensitive immunoblot assay. The method for performing this phage immunoblot, shown in FIG. 15, is described in the next paragraph.

Immunoblots for IgG and phage. Patient sera were diluted in PBS and 10 μl aliquots were loaded and ran on a precast protein PUN, agarose gel, in a Hydrasys instrument (SEBIA-USA, Norcross, Ga.) according to the manufacturer's instructions. The automated program was stopped after phoresis (40 Vh, ˜5 minutes) and not allowed to proceed to the gel drying step. The gel was removed from the instrument and contact blotted onto a nitrocellulose membrane (Protran BA83 0.2 μm nitrocellulose membrane; Whatman, Florham Park, N.J. or NitroBind Cast pure nitrocellulose 0.45 μm; General Electric Water & Process technologies, Minnetonka, Minn.), under 100 g of weight, for 30 minutes at room temperature. Placement of the gel relative to the membrane was noted with ink, demarking sample lanes and other features of interest. The gel was then removed and the membrane blocked with 2% milk PBST for 1 hour at room temperature. The membrane was rinsed twice with PBST and specific phage, prepared in 1% milk PBST, was added for an overnight incubation at 4° C. with rocking. The membrane was washed three times, 10 minutes each, with PBST, and mouse anti-M13-HRP conjugate was added, prepared as 1:5000 in 1% milk PBST, for 1½ hours at room temperature. The membrane was washed twice with PBST, once with PBS and any retained phage were visualized using a standard chemiluminescence protocol. Also, SPEP-blots were undertaken with patient sera diluted 1:1000 in PBS and these blots were developed with goat anti-human-IgG-HRP to reveal the location of the paraprotein, as an internal control for each run.

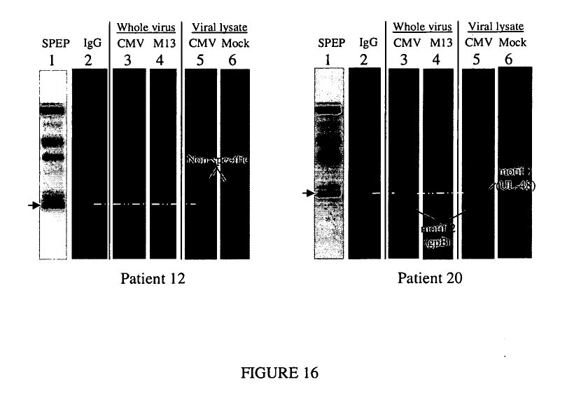

Agarose gel immunoblot with HCMV lysate and virions. In order to correlate specific paraproteins on the electrophoretic gel with its binding capability, we performed an immunoblot. We tested whether HCMV immunoreactivity co-migrates with the paraprotein on agarose gel electrophoresis. The serum protein electrophoretic patterns of patients 12 and 20, as stained with the protein dye amido black, are shown in lane 1 of FIG. 16, denoted “SPEP”. The sera of both patients 12 and 20 show a single paraprotein (arrows). The normal background of polyclonal immunoglobulins is absent, a common finding in MM. A more sensitive immunoblot reveals the presence of other IgG immunoglobulins besides the paraprotein (lane 2, FIG. 16).

In order to assess HCMV immunoreactivity, an agarose gel immunoblot method was used, [Nooija, F., et al. J. Immunol. Methods. (1990) 134:273-281; Knisley, K., et al. J Immunol Methods. (1986) 95:79-87.] (lanes 3-6). Since the immunoblot is several log orders more sensitive than the SPEP, sera were diluted in order to find a linear range of detection. For patient 12, the restricted band that binds to both intact HCMV virions (lane 3) and an HCMV lysate (lane 5) exactly aligns with the paraprotein (lane 1, arrow). Since glycoprotein B is a viral membrane protein, we expected patient 12's paraprotein to bind both the HCMV lysate and intact virion preparation. With intact virions, viral membrane proteins such as glycoprotein B are accessible for antibody binding.

The analysis for patient 20 (FIG. 16, right-hand side) is more complex because there is a dominant paraprotein, immunoreactive with the UL-48 gene product, as well as a minor paraprotein, immunoreactive with glycoprotein B. The dominant paraprotein is seen in the SPEP (lane 1, arrow). Although the SPEP fails to show any other immunoglobulins, the more sensitive immunoblot for IgG (lane 2, FIG. 16) reveals their presence. The HCMV immunoblots reveal that the dominant paraprotein aligns with the restricted band in the HCMV lysate lane (lane 5) but not with any band in the HCMV virion lane (lane 3). This is expected, since the UL-48 gene product is not present on the viral membrane. With intact HCMV virions, the paraprotein can not penetrate the viral membrane and bind to an internal protein, such as the UL-48 gene product. There is also a minor paraprotein, denoted “motif 2”, which binds to both the HCMV lysate (lane 5) as well as intact virions (lane 3). Since motif 2 relates to glycoprotein B specificity, binding to intact virions is expected. These findings collectively indicate that the two patients' paraproteins are HCMV-immunoreactive. The agarose gel immunoblot method used for FIG. 16 is described in the following paragraph.

Agarose gel immunoblot. For this assay, proteins are electrophoretically separated in an agarose gel. The proteins are then contact blotted onto an antigen-coated nitrocellulose membrane. Protein transfer requires that serum antibodies in the gel bind to antigen on the nitrocellulose membrane. Only immunoglobulins capable of binding to the antigen adhere. The nitrocellulose membrane is otherwise saturated with irrelevant proteins, largely preventing non-specific protein transfer Immunoglobulins that are bound to the nitrocellulose sheet are then visualized with a human IgG-specific antibody-enzyme conjugate.

Nitrocellulose membranes were incubated with specific phage prepared in 0.5 M bicarbonate buffer (pH 8.0), overnight at 4° C. with rocking. The membranes were then rinsed with PBST and blocked for 1 hour with 2% milk PB ST. In this variation of the immunoblot, the gels are allowed to contact the antigen-coated nitrocellulose membranes for 30 minutes at room temperature, sandwiched between two glass plates. The relative position of the gels to the membranes are marked in ink, and the gels are removed. The membranes are thoroughly washed three times in PSBT for a total of 30 minutes. Membranes are then incubated with goat anti-human IgG-HRP conjugate prepared as 1:5,000 in 1% milk PBST for 1½ hours at RT or overnight at 4° C., with rocking. Membranes were washed twice with PBST and once with PBS before development by chemiluminescense.

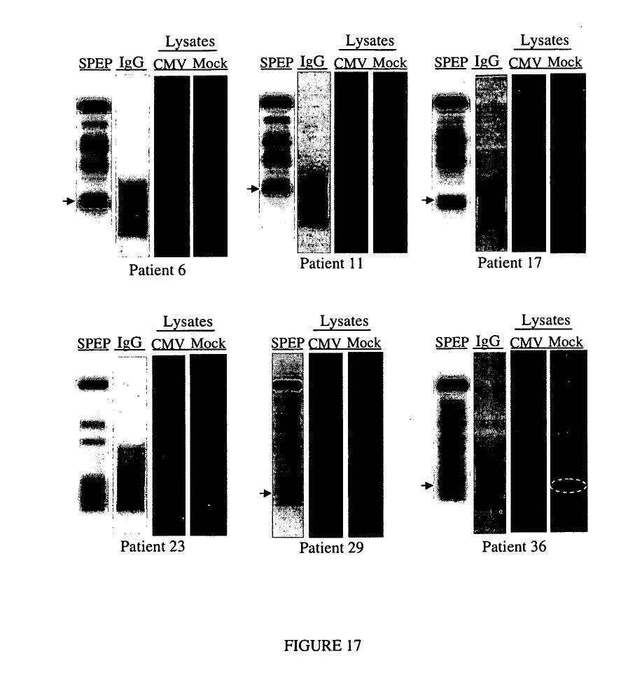

CMV-Reactive Paraproteins in Other MM Patients (FIG. 17)

Besides patients 12 and 20, we tested 24 other MM patients for immunoreactivity to HCMV lysates, using a commercial ELISA. Patient sera were diluted ten-fold more than recommended by the manufacturer, since the paraproteins are present in high concentrations. Ten sera were not reactive and therefore not further tested (data not shown). Fourteen of the 24 patients were seropositive (data not shown). We then performed agarose gel immunoblots on each of them, to determine if the paraprotein is the source of the HCMV immunoreactivity. Of the 14 seropositive MM patients, eight had bands on the HCMV lysates lane that co-migrate with the paraprotein seen on SPEP (FIG. 17). The remaining six had bands that were either ambiguous or did not align with the paraprotein.

The HCMV immunoblots in FIG. 17 sometimes provide insights not previously afforded by conventional SPEP or immunofixation. For example, patient 23 had a clinical diagnosis of MM but the SPEP and immunofixation demonstrate an unusually broad, diffuse IgG-kappa band. This was surprising since MM paraproteins are usually narrow, or “restricted”. The immunoblot reveals that the diffuse band is actually comprised of three distinct narrow bands, each of which binds to the HCMV lysate. Another finding is the presence of minor HCMV-binding paraproteins, not evident on SPEP or immunofixation. These minor bands represent clonal antibodies that bind to HCMV but are present at lower concentrations, below the level of detection for SPEP or immunofixation.

Identification of the Human Endogenous Retroviral K Envelope Glycoprotein (HERV-K Env) as a Paraprotein Target.

We identified the target antigen for the paraproteins of two other multiple myeloma patients who were not seropositive to CMV. Patient #14 is a 70 year-old man with a diagnosis of multiple myeloma, with an IgG-lambda monoclonal component representing >99% of the serum immunoglobulins. Patient #21 is a 75 year-old man with a diagnosis of multiple myeloma with an IgG-kappa monoclonal component representing >99.9% of the serum immunoglobulins. The motif for patient 14 is LNTPLVVP. The motif for patient 21 is KSIPTEP.

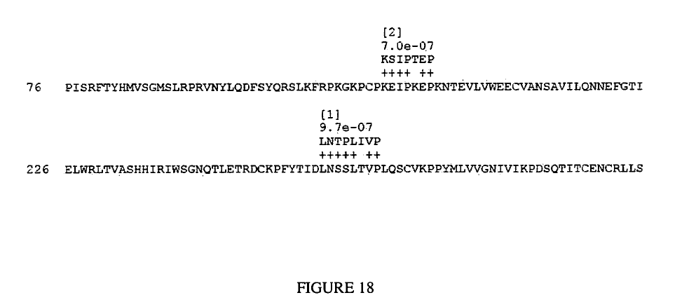

Both of these motifs' PSSMs were submitted to MAST in a simultaneous search of the nr database. The best possible match for both motifs was afforded by the human endogenous retrovirus K envelope protein (HERV-K Env) which appeared at position 1 and 56 of the database search results. The match can be seen in FIG. 18. For motif LNTPLVVP, 5/8 positions exhibited identity matches and 2/8 positions exhibited conserved substitutions, for a total of 7/8 (87.5%) maximal alignment. The motif KSIPTEP exhibited 5/7 identity matches and 1/7 conserved substitutions, for a total of 6/7 (85.7%) maximal alignment.

Human endogenous retroviruses (HERVs) comprise 9% of the human genome. They are relics of unexpressed proviruses that integrated into the germline genome of primate/human predecessors 40 million years ago. Most of the HERV sequences are defective due to accumulation of deletions or mutations. The HERV-K family consists of 30 to 50 proviruses and is the only human endogenous provirus to retain open reading frames for the Gag, Prt, Pol and Env viral proteins. Our finding of two paraproteins directed to HERV-K Env protein suggest that the retrovirus is expressed in some myeloma patients. Involvement of HERVs in multiple myeloma or, for that matter any other type of clonal B lymphoproliferative disease, has not been previously described.

Implications of the E-MAP Findings in Multiple Myeloma Pathogenesis

In this first clinical application of the E-MAP methodology, we find that a suprisingly high proportion of paraproteins in MM are directed to HCMV. Including patients 12 and 20, we found that at least 10 out of 26 MM patients had HCMV-reactive paraproteins. The fact that patient 20 had two separate paraproteins, both directed to different HCMV proteins, further suggests that HCMV is not a randomly chosen antigenic target. These findings raise potentially important implications for the pathogenesis, diagnosis, and treatment of MM.

Our findings suggest that HCMV may represent a viral stimulus that leads to MM in a subset of infected individuals. Following an initial infection, HCMV normally remains in a persistent, latent state within the host, controlled by the host's immune system. Nonetheless, the virus is capable of reactivation and shedding, even in seropositive immune-competent individuals. Thus, it likely represents a chronic immune stimulus, fostering the ongoing stimulation and growth of HCMV-specific B and T lymphocytes.

Our findings raise the possibility that persistent or repetitive chronic immune stimulation by HCMV may act as a tumor promoter, by causing clonal expansion of HCMV-reactive B lymphocytes. As the proliferating lymphocytes accumulate mutations, the evolving pre-malignant MM cell may require the presence of antigen, HCMV. This hypothesis is consistent with the clinically observed entity known as monoclonal gammopathy of undetermined significance (MGUS), a precursor of MM. Such persistent proliferative stimulation may predispose the pre-malignant MM cell, over time, to additional transforming events associated with dysregulation of cell cycle checkpoints and apoptotic pathways. By the time a clinical diagnosis of MM is made, the virus may no longer need to be productively expressed [Hermouet, S., et al. Leukemia. (2003) 17:185-195.], and the MM cells may no longer be antigen-dependent. If this hypothesis is true, then it raises the possibility that early intervention with anti-viral agents may prevent progression to frank malignancy. Moreover, if infection could be prevented with an effective vaccine [Khanna, R., et al. Trends Mol. Med. (2006) 12:26-33.], then many cases of multiple myeloma might potentially be prevented. These findings also have potential implications for other B lymphoproliferative disorders, apart from multiple myeloma. If antigen acts as a tumor promoter, then B lymphoproliferative disorders provide us with a unique fingerprint—the antibody itself—for identifying the relevant antigens promoting tumor growth. The E-MAP technology now allows us to match the fingerprints to disease targets.

Our findings of paraproteins directed to both CMV and HERV-K raise the possibility that the two are linked pathogenetically. In this regard, it is relevant that Herpesviridae have been shown to transactivate HERV-K elements. It is of special interest that the latent proteins from Epstein-Barr virus (a known oncogenic and lymphotropic virus that infects B cells) are sufficient to transactivate HERV-K Env, and presumably other proviral transcripts.

Implications of E-MAP For Diagnostic Test Development & Biomarker Discovery

The E-MAP technology may be highly valuable in biomarker discovery for the development of medical diagnostic tests. In this context, the antigen itself can serve as a clinically relevant biomarker. Our findings with regard to CMV and HERV-K raise the possibility that immunoassays, including electrophoretic immunoassays, may be valuable in the diagnosis, classification for treatment, or prognosis of lymphoproliferative disorders and gammopathies, such as multiple myeloma. These assays can take many forms, including both solid phase immunoassays, such as ELISA, as well as electrophoretic immunoassays, such as immunofixation-in-gel or immunoblots.

For example, one type of assay might represent a column comprised of a solid phase substrate, such as Sepharose, to which CMV or HERV-K (or their proteins or peptides) are immobilized. The patient's serum sample would be passed into the column and any CMV or HERV-K-specific antibodies will contact and bind to their respective binding partners. After a suitable incubation time, typically 15-60 minutes, the serum (or plasma) is rinsed out, leaving only the column-adherent antibody. The antibody can then be eluted, such as with acid (e.g., 10 mM glycine pH 2.5) or base. The eluate can then be neutralized and analyzed by electrophoresis, to determine if the eluted antibody co-migrates with the serum paraprotein identified on serum protein electrophoresis or immunofixation.

Another exemplary immunoassay for determining if the immunoglobulin secreted by the malignant cell (a.k.a. the paraprotein) is a solid phase immunoassay, such as an ELISA or microarray. In the latter alternative, various proteins or peptides derived from CMV or

HERV-K can be coupled to the array substrate using techniques that are well known in the art. A suitable method for covalent conjugation of peptides or viral proteins to glass, for example, is described in U.S. Pat. No. 6,855,490, also assigned to Medical Discovery Partners LLC, the same assignee on this patent application. In such an embodiment, the patient's serum or plasma sample is pipetted onto the array surface, allowing any antibodies to the array components to contact and bind to their respective protein or peptide targets. After a suitable incubation time, such as 15-60 minutes, the serum or plasma sample is removed. The surface is typically rinsed with a physiologic buffer, to wash away any weakly-binding antibodies or other serum proteins. Tightly-bound serum antibodies are then detected with a reagent that binds to human immunoglobulins, such as an anti-human immunoglobulin antibody conjugate. The reagent can be conjugated to one of many suitable labels, including fluorochromes (e.g., fluorescein) or enzymes (e.g., horseradish peroxidase). Depending upon the label, the presence of bound antibodies from the patient's serum sample is detected visually, such as with a fluorescence microscope or brightfield microscope.

Another possible format for an immunoassay to test paraprotein target specificity is a Western blot. In a Western blot, the proteins from CMV or HERV-K (in this case) would be separated out electrophoretically, such as by SDS-polyacrylamide gel electrophoresis. The proteins are then transferred onto a membrane, such as nitrocellulose or PVDF. The membrane with the separated proteins bound to the surface then serves as a kind of solid phase in an immunoassay, albeit on a membrane. The serum or plasma sample, for example, are then added to the membrane, usually contained in a vessel, so that the serum/plasma sample thoroughly contacts the membrane. After a suitable incubation time, non-adherent serum or plasma components are removed by rinsing the membrane surface with a physiologic buffer. The presence of tightly bound serum antibodies, such as a paraprotein, is then detected with a reagent that binds to human immunoglobulins, such as an anti-human immunoglobulin antibody conjugate, such as described in the preceding paragraph. Tightly-bound serum antibodies, such as paraproteins, will bind in the same general shape as the viral protein on the membrane, as it ran in the electrophoretic gel. Identifying the specific location of the bands on the membrane will facilitate a determination of the identity of each protein in the gel, since various viral proteins can be correlated with their known electrophoretic mobility. Electrophoretic mobility of specific viral proteins can be established by identifying them through a variety of means, including blotting with monoclonal antibodies to each of the major viral proteins in parallel to the patient sample.

Immunoassays such as ELISA, microarrays or Western blot will detect antibodies to immobilized components, but those antibodies may not necessarily be paraproteins (derived from a malignant cell). However, since serum paraproteins in patients with gammopathies (such as multiple myeloma) are usually present in high concentrations, it is reasonable to make the inference that the antibody is the serum paraprotein if the antibody titer is beyond that which would be expected from the normal background of polyclonal antibodies. For example, a threshold value is established beyond which only a small fraction of normal individuals are reactive. In testing patients with gammopathies, any positive results will have a statistical likelihood of being derived from the serum paraprotein, depending upon the established threshold value.

We envision at least three different applications for E-MAP as a discovery tool leading to new diagnostic assays. In a first application, biomarker identification might be useful for diagnostics that are linked to therapy. For example, if anti-viral therapy is useful in treating multiple myeloma, then it is of obvious importance to know which myeloma patients have tumors associated with a particular virus. If the patient's paraprotein and malignant myeloma cells express surface receptors specific to a particular protein or peptide, then treatment might be possible where the antigen receptors on the cells are blocked, depriving the cells of an essential growth stimulus. Patients whose myeloma cells are directed to other targets might not benefit from this particular therapy. Similarly, it is potentially possible that the antigen itself or a peptide, conjugated to a cytotoxic agent, might serve as a means to target the receptor as a tumor-specific antigen. Exemplary cytotoxic agents are well known in the field, and can include radionuclides and toxins/toxin subunits. With such types of antigen conjugates, identifying the antigen is important if the patient is to receive the proper drug.

In a second application, E-MAP analysis can be useful in identifying markers for assessing disease prognosis. A precursor of multiple myeloma is a clinical entity called monoclonal gammopathy of undetermined significance (MGUS). Approximately 3% of the population over 55 years of age may have paraproteins, but the vast majority have no symptoms whatsoever. Only a small proportion of patients with MGUS progress to multiple myeloma, which is a life-threatening disease. Distinguishing those who will progress from those who will not could allow for early intervention. Identifying the antigen to which the paraprotein is directed might be informative in predicting which patients with gammopathies will develop multiple myeloma and which will remain as MGUS. Certain antigens may be expected to be associated with progression. If the clonal B lymphocytes responsible for MGUS are stimulated by different antigens, then the nature of the antigen could have a profound effect on the disease course. Certain antigens may be naturally present in higher concentrations, which might further support proliferation of a partially transformed malignant B lymphocyte clone. Alternatively, certain microorganisms may cause transformation by other ancillary means, such as by inserting viral promoters or dysregulating cell cycle or apoptosis machinery, and thereby be more predisposed to generating a malignant response. Regardless of the exact mechanism, any type of immunoassay that identifies the antigen to which the paraproteins are directed might be useful for determining patient prognosis.

In a third embodiment, the E-MAP technology could be useful in biomarker discovery in tests for disease detection and disease monitoring. For example, knowing the precise antigen or even peptide epitope to which malignant cells bind allows one of ordinary skill to create more specific diagnostic reagents for the malignant B lymphocyte clone. Thus, instead of performing immunostains for kappa or lambda light chain, the peptides or protein antigens can be used as probes for identifying or quantifying the malignant cells. The peptide or protein antigens can be conjugated to moieties such as fluorochromes or enzymes, in order to detect their presence in an immunoassay. This type of antigen conjugate could then be used in flow cytometry, immunofluorescence, immunohistochemistry, or any other cellular assay. For example, such a conjugate could be useful in detecting minimal residual disease and quantifying the residual malignant cell fraction. In addition, the antigen conjugate can be used for detecting and quantifying a secreted paraprotein. Since the paraprotein will bind to the antigen, there are various methods by which an immunoassay might be designed to quantify a paraprotein. For example, the antigen might be immobilized onto a solid phase substrate, such as for an ELISA. Alternatively, the antigen might be used in a precipitation assay, such as for immunofixation analysis. Currently, clinical laboratories use antibodies to various immunoglobulin subtypes (IgG, IgA, IgM, kappa or lambda light chains) to precipitate paraproteins in an agarose electrophoretic gel. The E-MAP method allows us to now identify antigens that can cross-link the paraproteins in place, in the gel. This method may provide higher resolution of the paraproteins, since they would be more specific than the broad categories of immunoglobulin subtypes.

Although we describe an application of E-MAP to multiple myeloma, many of the same conclusions and clinical opportunities exist for many other gammopathies. In fact, some gammopathies, such as MGUS or amyloidosis AL, may be more dependent on the presence of antigen for cellular growth than multiple myeloma. Thus, therapies aimed at suppressing the concentration of antigen may be more effective in some of these other clinical entities. Besides gammopathies, E-MAP should also be expected to be useful in a similar manner to other B lymphoproliferative disorders such as non-Hodgkin's lymphoma and chronic lymphocytic leukemia. Like multiple myeloma, E-MAP analysis of their B cell receptor immunoglobulin will be expected to identify the antigen to which these clonal B lymphocyte proliferations are directed. Thus, the same therapeutic and diagnostic opportunities exist for these clinical entities. In fact, since there is a much lower concentration of secreted immunoglobulin, some therapeutic options (such as antigen-toxin conjugates) may even be more useful in these other B lymphoproliferative disorders.

E-MAP analysis may also be useful in studying immune responses in other clinical entities, such as autoimmunity. E-MAP analysis can facilitate the identification of protein antigens linked to an autoimmune process. Identifying relevant antigens in autoimmune diseases may be diagnostically or therapeutically useful, in therapeutic target identification or in one or more of the diagnostic biomarker contexts previously described.

E-MAP analysis may also be useful in studying diseases of unknown etiology. To the extent that the immune response targets a pathogenetically-relevant protein antigen in a disease of unknown cause, E-MAP can identify these antigens as useful therapeutic or diagnostic targets. Exemplary diseases to which E-MAP can be applied includes granulomatous diseases of unknown cause, including sarcoidosis, Crohn's disease, and giant cell arteritis. In each disease, the cause is not known and there is debate as to whether any or all of them might be caused by an infectious agent. By identifying proteins targeted by the immune system in affected patients, E-MAP analysis can narrow the universe of potential etiologies to a short list, for further evaluation.

The pairwise approach of bioinformatic analysis described for E-MAP analysis, is also applicable to T lymphocytes as well. Pairwise analysis of T lymphocyte targets can help narrow down the list of candidate target proteins in a similar manner as described for antibody epitopes. In fact, since T lymphocytes only recognize linear epitopes, the analysis may be even simpler. Of course, epitope analysis of T lymphocytes requires a different methodology using T lymphocyte clones or purified T cell receptor. However, once the epitopes are experimentally reconstructed, the bioinformatic analysis that we describe is directly applicable.

A number of embodiments of the invention have been described. Nevertheless, it will be understood that various modifications may be made without departing from the spirit and scope of the invention. Accordingly, other embodiments are within the scope of the following claims.

What is claimed is:

1. A method for identifying a protein to which an antibody binds through its antigen-binding domain, the protein being previously unknown, comprising:
identifying a consensus peptide sequence to which the antibody binds, comprising at least the steps of:
contacting the antibody with a random peptide library;
selecting for peptides from the library that bind to the antibody;
screening the selected peptides for those that bind most strongly to the antibody;
deriving the peptide sequences for the screened peptides;
analyzing the derived peptide sequences so as to identify a consensus peptide sequence;
searching a protein database for proteins that contain homologous sequences to the consensus peptide sequence and retrieving those proteins from the database;
verifying that the antibody binds to a protein retrieved from the database search.

2. The method of claim 1, wherein the screening of the selected peptides for those that bind most strongly to the antibody, comprises immunobloting.

3. The method of claim 1, further comprising a rank ordering of the database search results on the basis of the degree of homology to the consensus sequence.

4. The method of claim 1, wherein the antibody is a monoclonal antibody.

5. The method of claim 1, wherein the consensus peptide sequence comprises at least seven amino acids.

6. The method of claim 1, wherein the protein database search comprises microbial proteins and the consensus peptide sequence has at least five amino acids.

7. The method of claim 1, further comprising using an immunoassay that incorporates at least a portion of a protein retrieved from the database search in order to detect antibodies that are immunoreactive with the retrieved protein.

8. The method of claim 7, wherein the immunoassay comprises the steps of:
separating proteins of a serum sample electrophoretically ;
contacting the proteins with said at least a portion of a protein retrieved from the database; and
detecting whether said at least a portion of a protein retrieved from the database is immunoreactive with antibodies in the serum sample.

9. The method of claim 1, wherein verifying that the antibody binds to a protein comprises an immunoassay that includes the protein, or a cleavage fragment of the protein, or a synthetic peptide having homology to a portion of the protein's sequence.

10. The method of claim 1, wherein the consensus peptide sequence that is used for searching a protein database comprises a position-specific scoring matrix.

11. A method for identifying a protein to which an antibody binds through its antigen-binding domain, the protein being previously unknown, comprising:
identifying a consensus peptide sequence to which the antibody binds, comprising at least the steps of:
contacting the antibody with a random peptide library;
selecting for peptides from the library that bind to the antibody;
screening the selected peptides for those that bind most strongly to the antibody;
deriving the peptide sequences for the screened peptides;
analyzing the derived peptide sequences so as to identify a consensus peptide sequence;
performing said steps on a second antibody that may bind to the same protein;
searching a protein database with the consensus peptide sequences from both the first and second antibodies for proteins that contain homologous amino acid sequences to both;
retrieving the protein database search results that have homologous sequences to both consensus peptide sequences;
verifying that the antibody binds to a protein retrieved from the database search.

12. The method of claim 11, wherein the screening of the selected peptides for those that bind most strongly to the antibody, comprises immunobloting.

13. The method of claim 11, further comprising a rank ordering of the database search results on the basis of the degree of homology to the consensus sequence.

14. The method of claim 11, wherein the antibodies are monoclonal antibodies.

15. The method of claim 11, further comprising using an immunoassay that incorporates at least a portion of a protein retrieved from the database search in order to detect antibodies that are immunoreactive with the retrieved protein.

16. The method of claim 15, wherein the immunoassay comprises the steps of:
separating proteins of a serum sample electrophoretically;
contacting the proteins with said at least a portion of a protein retrieved from the database;
detecting whether said at least a portion of a protein retrieved from the database is immunoreactive with antibodies in the serum sample.

17. The method of claim 11, wherein verifying that the antibody binds to a protein comprises an immunoassay that includes the protein, or a cleavage fragment of the protein, or a synthetic peptide having homology to a portion of the protein's sequence.

18. The method of claim 11, wherein the consensus peptide sequence that is used for searching a protein database comprises a position-specific scoring matrix.
